(19) United States
(12) Patent Application Publication
(10) Pub. No.: US 2024/0323903 A1
(43) Pub. Date: Sep. 26, 2024

(54) Apparatus Comprising a Transceiver, Method for Performing Position Determination and Positioning System

(71) Applicant: Fraunhofer-Gesellschaft zur Förderung der angewandten Forschung e.V., München (DE)

(72) Inventors: Birendra GHIMIRE, Erlangen (DE); Mohammad ALAWIEH, Erlangen (DE); Ernst EBERLEIN, Erlangen (DE); Norbert FRANKE, Erlangen (DE); Andreas EIDLOTH, Erlangen (DE)

(21) Appl. No.: 18/678,298

(22) Filed: May 30, 2024

Related U.S. Application Data
(63) Continuation of application No. PCT/EP2022/084285, filed on Dec. 2, 2022.

(30) Foreign Application Priority Data
Dec. 3, 2021 (EP) 21212406.9
Jan. 28, 2022 (EP) 22153858.0

(51) Int. Cl. H04W 64/00; H04L 5/00; H04W 8/22

(52) U.S. Cl. CPC H04W 64/00; H04L 5/0051; H04W 8/22

(57) ABSTRACT

Apparatus being a first or second apparatus comprising a transceiver and configured to communicate to a second apparatus; wherein the first apparatus is configured to transmit first and second reference signal also referred to as double burst forward link to the second apparatus so that the second apparatus receives the first and the second reference signal in order to calculate a first phase difference d_{φ1} (d_{φ1}=angle(RS_{22,RX})−angle(RS_{21,RX})) between the first and the second reference signal and/or to report the first phase difference d_{φ1}; wherein the first apparatus is configured to receive from the second apparatus third and fourth reference signal also referred to as to double burst return link in response to the first and second reference signal in order to calculate a second phase difference d_{φ2} (d_{φ2}=angle(RS_{12,RX})−angle(RS_{11,RX})) between the third and the fourth reference signal, and/or to report second phase difference d_{φ2}; wherein a distance and/or a distance change and/or a relative speed (v) of the first and the second apparatus is calculable based on d_{φ1} and d_{φ2} or based on the formula d_{φMovement}=(d_{φ1}+d_{φ2})/2.

### CROSS-REFERENCE TO RELATED APPLICATIONS

This application is a continuation of copending International Application No. PCT/EP2022/084285, filed Dec. 2, 2022, which is incorporated herein by reference in its entirety, and additionally claims priority from European Applications Nos. EP 21212406.9, filed Dec. 3, 2021, and EP 22153858.0, filed Jan. 28, 2022, which are all incorporated herein by reference in their entirety.

Some embodiments of the present invention refer to an apparatus (e.g., first apparatus) like a user equipment or to another apparatus (e.g., second apparatus/user equipment). Further embodiments refer to the corresponding methods for performing position determination and to a position system. Embodiments refer to relative positioning measurements using double phase difference methods.

### BACKGROUND OF THE INVENTION

FIG. 10 is a schematic representation of an example of a terrestrial wireless network 100 including, as is shown in FIG. 10(a), the core network 102 and one or more radio access networks RAN₁, RAN₂, . . . RAN_{N}. FIG. 10(b) is a schematic representation of an example of a radio access network RANₙ that may include one or more base stations gNB₁ to gNBS, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 10(b) shows an exemplary view of five cells, however, the RANₙ may include more or less such cells, and RANₙ may also include only one base station. FIG. 10(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 10(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 10(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 10(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 10 may be a heterogeneous network having distinct overlaid networks, e.g., a network of macro cells with each macro cell including a macro base station, like base station gNB₁ to gNB₅, and a network of small cell base stations, not shown in FIG. 10, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 10, for example in accordance with the LTE-Advanced Pro standard or the 5G or NR, new radio, standard.

In mobile communication networks, for example in a network like that described above with reference to FIG. 10, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE or a subset of it, depending on the specific network configuration. Other UEs may not be vehicular related UEs and may comprise any of the above-mentioned devices. Such devices may also communicate directly with each other, D2D communication, using the SL channels. When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 10. This is referred to as an “in-coverage” scenario. Another scenario is referred to as an “out-of-coverage” scenario. It is noted that “out-of-coverage” does not mean that the two UEs are not within one of the cells depicted in FIG. 10, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 11 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 10. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 12 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 12 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 11, in addition to the NR mode 1 or LTE mode 3 UEs 202, 204 also NR mode 2 or LTE mode 4 UEs 206, 208, 210 are present. In addition, FIG. 12, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 11 and FIG. 12 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

Measuring the distance between two devices or the relative speed is needed for many applications. 3 types of implementations for relative distance and speed measurements can be considered:
Optical systems and radar using (very high) carrier frequency offer a high accuracy for LOS conditions.
Supersonic based sensors are efficient for short (a few meters) distances.
RF frequency (e.g. RF frequencies in the range 1 to 6 GHz) offer a high accuracy and are able to work also at NLOS conditions. These frequencies may be also suitable for distance ranges of several 100m up to several kilometers

The proposed solution focus on RF frequency applications and shall allow the (relative) speed measurement between two devices. Related applications may be V2X scenarios, for example.

This situation is shown by FIG. 1. FIG. 1 shows three vehicles, wherein the first vehicle 10a and the second vehicle 10b comprise a transceiver as indicated by the RF antenna signal. The two vehicles 10a, 10b as well as the third vehicle 11 for a platoon, wherein the third vehicle 11 does not have or has an inactive transceiver. In a shown situation wherein the vehicle 11 is between a vehicle 10a and 10b, the vehicle 11 just blocks the optical and/or radar signal from the first vehicle 10a following subsequent to the third vehicle 11 in the platoon. This enables that the first vehicle 10a can determine the third vehicle 11 using a radar sensor as indicated by the radar sensor signal. Furthermore, the two vehicles 10a and 10b can communicate with each other using RF signals on the multipath propagation channel, wherein the LOS path may be obstructed (“OLOS”) as indicated by the transmission line from the first vehicle 10a to the second vehicle 10b.

As an example, a car-to-car distance measurement application is considered. Car 1, 10a, wants to measure the distance to the other cars 10b and 11 ahead. The distance for car 3, 11, may be measured with optical (e.g., camera, LIDAR, . . . ) or (very) high frequency RF signals, e.g., radar. The LOS (line-of-sight) link to car 2, 10b, may be blocked for optical and very high frequency RF signals by car 3, 11.

For RF signal at low and medium frequencies (frequency range below 6 GHz, for example) the RF signal is typically not fully blocked due to diffraction and multipath propagation (e.g. ground reflection) the signal can be still received. The related channel condition is typically called “OLOS” (=obstracted LOS) or NLOS (non-line-of-sight).

For safety and speed control it may be useful to continuously measure the distance change or relative speed of the cars ahead (car 2 and other cars ahead) with high precision and low latency (e.g. latency <100 ms). This may be difficult to implement using concepts like reporting of the position.

Beside for driving-car-to-driving-car applications, a low latency distance change measurement may be also applicable for car-to-roadside-units or car-to-pedestrian applications. It may be further possible to combine the distance change measurement with
Round-trip-time (RTT) measurements to get on top of the distance change the distance. For the distance a higher latency or lower accuracy may be acceptable, especially if the second device is still far away. For devices close to the car other sensors may be used.
angle-of-arrival (AoA) or angle-of-departure (AoD) measurements to distinguish between “device 2, 10b” is ahead or behind the car (device 1, 10a).

The below discussion of the conventional concept for the problem described in the context of FIG. 1 will be given. Within the discussion of conventional technology also a discussion of the drawbacks is made so that the identification of the problems are part of the inventive concept.

RTT (RoundTrip Time) is a method to measure the distance between two devices. The time-of-flight is measured by measuring the time-of-transmit (ToT) and time-of arrival (ToA). Typically sequences with good auto-correlation properties such as DL-PRS (Down-link positioning reference signal) or SRS (sounding reference signal) are transmitted. The measurement accuracy depends on the signal bandwidth and the multipath propagation conditions. For good propagation conditions and medium bandwidth (e.g. 100 MHz) nanosecond accuracy (app. 30 cm) is feasible.

For speed measurements the change of the distance can be used. To achieve a desired accuracy the device has to travel a distance much higher than the measurement accuracy. As an example, we assume a speed of 50 km/h (13.9 m/s) and a minimum position change of 10*30 cm=3m for the speed measurement with 10% accuracy, assuming a ToA measurement accuracy of 30 cm. For the given speed the measurement duration would be 216 ms (not including time for reporting the measurements). For low latency applications like semi-autonomous driving this may be too high. Furthermore, for lower speed the accuracy may be reduced.

Other methods may report several positions and the distance is calculated by the difference of the positions. This involves a very high position accuracy.

If one device is embedded in a car, for example, the car may include speed sensors and can at least report the speed. For the relative speed between two devices the driving direction is also relevant. Therefore additional sensors may be needed in this case, if especially the relative distance (change) or the relative speed is of interest.

In this invention we propose a direct relative distance change solution based on the change of the carrier phase. Carrier phase measurement for high precision positioning is discussed for example in [R1-1901186] and [RedFIR]. Using the carrier phase has pros and cons:

### Pros:

Already small position changes (“millimeter”) have a high impact to the phase. As an example, we assume a carrier frequency of 3.5 GHz (wavelength 8.57 cm) the carrier phase changes by 4.2 degree for a position change of 1 millimeter.

### Cons:

The phase measurement has an ambiguity of 360 degree (equivalent to the wavelength). This ambiguity is to be resolved by complementary ToA measurements or other methods.

The measured carrier phase change between two measurements depends also on the frequency offsets between the transmitting and receiving device. Assuming a frequency offset of 0.2 ppm (700 Hz @ 3.5 GHz) and a time of one millisecond between two measurements the resulting phase change is 252 degree.

Therefore, there is the need for an improved approach.

### SUMMARY

One embodiment may have an apparatus being a first apparatus and belonging to a positioning system comprising the first apparatus and a second apparatus, the first apparatus comprising a transceiver and configured to communicate to the second apparatus; wherein the first apparatus is configured to transmit a first reference signal at a first point of time and at least a second reference signal at a second d point of time (first and second reference signal also referred to as double burst forward link) to the second apparatus, so that the second apparatus receives the first and the second reference signal in order to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity of the positioning system, like the LMF, or to the first apparatus; wherein the first apparatus is configured to receive from the second apparatus a third reference signal at a third point of time and at least a fourth reference signal at a fourth point of time (third and fourth reference signal (16a, 16b) also referred to as to double burst return link); and to calculate a second phase difference d_{φ2} (d_{φ2}=angle(RS_{12,RX})−angle(RS_{11,RX})) between the third and the fourth reference signal (16a, 16b), and to report the second phase difference d_{φ2} or an angle(RS_{12,RX}) and angle(RS_{11,RX})) to another entity, like the LMF, or to the second apparatus; wherein the first apparatus or the another entity is configured to calculate a distance change or a relative speed (v) of the first and the second apparatus based on the first phase difference d_{φ1} and the second phase difference d_{φ2} or based on the formula d_{φMovement}=(d_{φ1}+d_{φ2})/2.

Another embodiment may have an apparatus being a first apparatus and belonging to a positioning system comprising the first apparatus and a second apparatus, the first apparatus comprising a transceiver and configured to communicate to the second apparatus; wherein the first apparatus is configured to transmit a first reference signal at a first point of time and at least a second reference signal at a second point of time (first and second reference signal also referred to as double burst forward link) to the second apparatus; wherein a first phase difference d_{φ1} (d_{φ1}=angle(RS_{22,RX})−angle(RS_{21,RX})) between the first and the second reference signal is calculable; wherein the first apparatus is configured to receive from the second apparatus a third reference signal at a third point of time and at least a fourth reference signal at a fourth point of time (third and fourth reference signal also referred to as to double burst return link); wherein a second phase difference d_{φ2} (d_{φ2}=angle(RS_{12,RX})−angle(RS_{11,RX})) between the third and the fourth reference signal is calculable, and wherein the first apparatus is configured to report the phase difference d_{φ2} or an angle(RS_{12,RX}) and angle(RS_{11,RX})) to another entity of the positioning system, like the LMF, or to the second apparatus; wherein the first apparatus or the another entity is configured to calculate a distance change or a relative speed (v) of the first and the second apparatus based the first phase difference d_{φ1} and on the phase difference d_{φ2} or based on the formula d_{φMovement} =(d_{φ1}+d_{φ2})/2.

Another embodiment may have an apparatus being a second apparatus and belonging to a positioning system comprising the first apparatus and a second apparatus, the second apparatus comprising a transceiver and configured to communicate to the first apparatus; wherein the second apparatus is configured to receive a first and the second reference signal from the first apparatus and to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity, like the LMF, or to the first apparatus; or wherein the second apparatus is configured to receive a first and a second reference signal and to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity of the positioning system, like the LMF, or to the first apparatus; wherein the second apparatus is configured to transmit a third reference signal at a first point of time and at least a second reference signal at a fourth point of time (third and fourth reference signal also referred to as to double burst return link) so that a second phase difference d_{φ2} (d_{φ2}=angle(RS_{12,RX})−angle(RS_{11,RX})) between the third and the fourth reference signal is calculable; wherein the second apparatus or the another entity is configured to calculate a distance change or a relative speed of the first and the second apparatus based the first phase difference d_{φ1} and on the phase difference d_{φ1} or based on the formula d_{φMovement}=(d_{φ1}+d_{φ2})/2.

Another embodiment may have another apparatus being the second apparatus and belonging to a positioning system comprising the first apparatus and a second apparatus, the first apparatus comprising a transceiver and configured to communicate to the first apparatus which transmits a first reference signal at a first point of time and at least a second reference signal at a second point of time (first and second reference signal also referred to as double burst forward link) to the second apparatus; wherein the second apparatus is configured to receive the first and the second reference signal in order to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity of the positioning system, like the LMF, to the first apparatus; wherein the second apparatus is configured to transmit a third reference signal at a third point of time and at least a fourth reference signal at a fourth point of time (third and fourth reference signal also referred to as to double burst return link) in response to the first and second reference signal to the first apparatus; in order to calculate a second phase difference d_{φ2} (d_{φ2}=angle(RS_{12,RX})−angle(RS_{11,RX})) between the third and the fourth reference signal, and to report the second phase difference d_{φ2} or an angle(RS_{12,RX}) and angle(RS_{11,RX})) to another entity, like the LMF, or to the second apparatus; wherein the another apparatus or the another entity is configured to calculate a distance change or a relative speed of the first and the second apparatus based on the phase difference d_{φ1} and the phase difference d_{φ2} or based on the formula d_{φMovement}=(d_{φ1}+d_{φ2})/2.

According to another embodiment, a positioning system may have at least the first inventive apparatus and the second inventive apparatus.

According to another embodiment, a method for performing position determination performed by a first apparatus belonging to a positioning system comprising the first apparatus and a second apparatus, the first apparatus, may have the steps of: transmitting a first reference signal at a first point of time and at least a second reference signal at a second point of time (first and second reference signal also referred to as double burst forward link) to a second apparatus, so that the second apparatus receives the first and the second reference signal in order to calculate a first phase difference d_{φ1} (d_{φ1}=angle(RS_{22,RX})−angle(RS_{21,RX})) between the first and the second reference signal and to report the first phase difference d_{φ1} or the angle(RS_{22,RX}) and angle(RS_{21,RX})) to another entity, like the LMF, to the first apparatus; receiving from the second apparatus a third reference signal at a third point of time and at least a fourth reference signal at a fourth point of time (third and fourth reference signal also referred to as to double burst return link) in response to the first and second reference signal, in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus; calculating a distance or distance change or a relative speed (v) of the first and the second apparatus based on d_{φ1} and d_{φ2} or based on the formula d_{φMovement}=(d_{φ1} +d_{φ2})/2.

According to another embodiment, a method for performing position determination performed by a second apparatus belonging to a positioning system comprising the first apparatus and a second apparatus, the first apparatus, may have the steps of: receiving a first and at least a second reference signal transmitted by the first apparatus, the first reference signal is transmitted at a first point of time (t1) and the second reference signal is transmitted at a second point of time (first and second reference signal also referred to as double burst forward link) in order to calculate a first phase difference d_{φ1} (d_{φ1}=angle(RS_{22,RX})−angle(RS_{21,RX})) between the first and the second reference signal and to report the first phase difference d_{φ1} or the angle(RS_{22,RX}) and angle(RS_{21,RX})) to another entity, like the LMF, to the first apparatus; transmitting a third reference signal at a third point of time and at least a fourth reference signal at a fourth point of time (third and fourth reference signal also referred to as to double burst return link) in response to the first and second reference signal to the first apparatus, in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus; calculating a distance or distance change and/or a relative speed (v) of the first and the second apparatus based on d_{φ1} and d_{φ2} or based on the formula d_{φMovement}=(d_{φ1}+d_{φ2})/2.

Another embodiment may have a non-transitory digital storage medium having a computer program stored thereon to perform the inventive method when said computer program is run by a computer.

According to an embodiment, an apparatus is provided (being a first apparatus, or alternatively a second apparatus). The apparatus may, for example, be a user equipment and comprises a transceiver and is configured to communicate to a second apparatus. Here, the communication should be understood as exchanging signals. The first apparatus is configured to transmit a first reference signal at a first point of time and at least a second reference signal at a second point of time to the second apparatus. The first and the second reference signal may form a first set of reference signals, also referred to as a double burst forward signal. The transmission has the purpose that the second apparatus can receive the first and the second reference signal in order to calculate a first phase difference d_{φ1} between the first and the second reference signal. The first phase difference d_{φ1} may be defined by d_{φ1}=angle(RS_{22,RX})−angle(RS_{21,RX}), which is the phase difference measured by the second apparatus on the signal received from the first apparatus. The second apparatus may report the measured phase d_{φ1} to the fist apparatus. Additionally or alternatively, the second apparatus can report the first phase difference d_{φ1} or the angle (RS_{22,RX}) and angle (RS_{21,RX}) to the first apparatus or another entity like the LMF. The first apparatus is configured to receive from the second apparatus a third reference signal at a third point of time and at least a fourth reference signal at a fourth point of time in response to the first and second reference signal. The third and fourth reference signals from the second set of reference signals, also referred to as double burst return link signal. This has a purpose to calculate a second phase difference d_{φ2} between the third and the fourth reference signal. d_{φ2} may be defined by d_{φ2}=angle(RS_{12,RX})−angle(RS_{11,RX}) and is the measured phase difference on the signal transmitted from the second apparatus to the first apparatus. Additionally or alternatively, this may have the purpose to report a second phase difference d_{φ2} or the angle (RS_{12,RX}) and angle (RS_{11,RX}) to the second apparatus or to another entity, like the LMF. A distance or a distance change or a relative speed of the first and the second apparatus is calculable based on d_{φ1} and d_{φ2} or based on the formula d_{φMovement}=(d_{φ1}+d_{φ2}) /2.

Embodiments of the present invention are based on the principle that a first apparatus/first user equipment or first vehicle having a transceiver outputs a so-called double burst forward link to a second apparatus so that the second apparatus receives the reference signals in a manner so that the first phase difference d_{φ1} between the two reference signals of the double burst forward link is calculable. The calculation can be performed by the second apparatus or alternatively another entity, like the LMF. In case the calculation is performed by the second apparatus, the second apparatus reports the phase difference d_{φ1} (measurement performed on the signal received from the first apparatus). In case the calculation is performed by another entity, like the LMF, just the angle RS_{22,RX} and RS_{21,RX} are report to another entity. The first apparatus, vice versa, is configured to receive from the second apparatus a double burst return link in response to the double burst forward link.

Based on the received double burst return link a second phase difference d_{φ2} between the third and fourth reference signal of the double burst return link is calculable. The calculation can be performed by the first apparatus or another entity.

In case the first apparatus does not perform the distance or relative velocity calculation, the first apparatus can report the phase difference d_{φ2} to another entity, like the LMF. In case the calculation of d_{φ2} is performed externally, just angle (RS_{12,RX}) and angle (RS_{11,RX}) are reported. The two phase differences d_{φ1} and d_{φ2} enable a beneficial calculation of the distance or distance change or distance change over time, i.e., a velocity. Thus, embodiments of the present invention are based on the finding that the measurement phase change is the sum of the phase change resulting from the frequency offset and the (relative) distance change. The use of the double phase different method enables to separate the frequency offset and the relative distance change, so that it is possible to determine the distance/distance change based on this method. This leads to the advantage of a high position accuracy while having low measurement latency.

According to embodiments, the first phase difference d_{φ1} is calculated by the second apparatus (based on measured values) or alternatively by the first apparatus (based on reported values). Vice versa, the second phase difference d_{φ2} is calculated by the first apparatus (based on measured values) or alternatively by the second apparatus (based on reported values).Alternatively, the first and second phase difference d_{φ1} and d_{φ2} may be calculated by another entity, e.g. the LMF.

According to further embodiments, a distance or the distance change or the relative speed is calculated by the first apparatus and/or the second apparatus or an LMF. Of course, other entities instead of the LMF may perform the calculation. The other entity has access to the first and second phase difference d_{φ1} and d_{φ2} or to the measured phases (angle (RS_{22,RX}), (RS_{21,RX}), (RS_{12,RX}), (RS_{11,RX}).

According to embodiments, the calculation of the distance change and/or relative speed (v) is based on the assumption that a frequency offset between a center frequency of the first apparatus and a second apparatus is df₁=f_{CD1}−f_{CD2}, wherein the expected phase difference is d_{φ1}=2*π*df₁*dt₁+d_{φMovement}, where d_{φMovement} represents the phase change resulting from the distance change.

Note, the phase change may result from a frequency offset and a relative distance change. Due to the selected approach, the phase change between two measurements resulting from frequency offset is eliminated, so that the relative distance change can be extracted.

According to embodiments, a distance change dd is calculated based on the following formula

$$dd = - d {φ}_{Movement} / {( {2}^{*} π )}^{*} λ .$$

According to further embodiments, wherein the relative speed (v) is calculated based on the following formula

$$v = dd / {dt}_{1} .$$

According to further embodiments, the frequency offset may be used. The frequency offset df may be calculated using the difference of d_{φ1} and d_{φ2} and/or based on the following formula

$$df = {df}_{1} = - {df}_{2} = ( d {φ}_{1} - d {φ}_{2} ) / ( {4}^{*} {π}^{*} {dt}_{1} ) .$$

According to embodiments, the phase measurement of the first, second, third and/or fourth reference signal (and of course of further reference signals) comprises a cyclic correlation. For example, a phase measurement of the first, second, third and/or fourth reference signal is performed in a frequency domain. Alternatively, the measurement is performed so that a phase of the first, second, third and/or fourth reference signal is derived from a complex valued correlation function in a time/delay domain.

According to embodiments, phase measurement of the first set, comprising the first and second reference signal or at least the first and second reference signal and/or a phase measurement on the second set (comprising the third and fourth reference signal or at least the third and fourth reference signal) is performed on a DL-PRS signal, so that a measured phase difference is derived from phase measurements on different parts of the DL-PRS signal. Note, the DL-PRS uses several OFDM symbols and different OFDM symbols which are selected for the phase measurements.

According to further embodiments, a phase measurement on the first set (comprising first and second reference signals) and/or on the second set (comprising third and fourth reference signals) is performed on a SRS signal so a measured phase difference is derived from phase measurements on different parts of a SRS signal. Note, the SRS uses several OFDM symbols with or without staggering.

According to further embodiments, a phase measurement on the first set (e.g. first, second reference signal) and/or the second set (third and fourth reference signal) is a DM-RS signal or a CSI-RS signal or other double burst signal or other signal containing at least two symbols.

According to further embodiments, a phase measurement on the first set (e.g. first, second reference signal) and/or the second set (third and fourth reference signal) is composed of two or more OFDM symbols containing a sequence known to the receiver or a sequence which can be reconstructed by the receiver. For example, a data signal is decoded and from the decoded signal the transmitted signal without propagation errors is reconstructed.

According to another embodiment, the first apparatus (or the LMF) is informed which two resources belonging to a resource set are transmitted coherently by the TRP and/or a second UE. For example, the first apparatus is informed via the LMF (although the information are received from NG-RAN). Alternatively or additionally, the first apparatus is requested for phase measurement by a message from the LMF, gNB or another entity.

According to embodiments, the first apparatus or a LMF communicating with the first apparatus receives information indicating phase Coherency between two resources is expected to receive these resources in a phase coherent manner, e.g. frequency offset not adjusted between two transmissions.

According to another embodiment, the first apparatus or a LMF communicating with the first apparatus is configured to request on-demand PRS where a PRS is transmitted phase coherent with the existing PRS, or where two resources are requested to be phase coherent with one another or where explicit parameters defining the DL-PRS resource are requested.

According to embodiments, a configuration of wide bandwidth DL-PRS with lower periodicity and narrowband DL-PRS pairs with higher periodicity is used to allow lower update rate of coarse range and higher update rate of finer range.

According to embodiments, the second apparatus is configured to perform the measurement on the first set of symbols and to report on the measured phase d_{φ1} or the angle(RS_{22,RX}) and angle(RS_{21,RX})) or more symbols belonging to the same set; and/or wherein the first apparatus is configured to perform the measurement on the second set of symbols and to report on the measured second phase d_{φ2} or angle(RS_{12,RX}) and angle(RS_{11,RX})) or more symbols belonging to the same set.

Note, the first and/or second apparatus and/or the transmission of the first, second, third and fourth reference signal is configured based on an RS configuration information provided by the network or another apparatus.

According to embodiments, the first and/or second apparatus is configured to receive an RS configuration. For example, the RS configuration comprises at least one of the following settings
Measurement update rate (measurement period)
Number of RS-RR (Reference Signals used for Relative Ranging) transmissions related to one measurement (2 or more RS signal transmission per direction). For one set of measurements a “RS-RR set” can be defined
“RS-RR set” is defined by
   Time difference between the RSs belonging to one set (dt₁ and dt₂).
   Bandwidth of the RSs (complete carrier bandwidth or part of it)
   Other parameter of the RSs (sequence ID, COMB-factor, COMB offset, cyclic shift, . . . )
   Number of OFDM symbols per RS (one or more)
   Maximum time difference between the start of the RS for forward link and return link (difference between t3 and t1)
dt₁ and dt₂ is selected according the frequency offset range and the speed range
The difference between t3 and t1 is not critical and is selected according to the frequency stability
   The return link may transmit after receiving the forward link signal: t3 >t1 and t3 >t2
   Interlaced: t3 >t1 and t3<t2
   The return link may transmit before the forward link: t3<t1
Several UEs may respond to one UE, e.g.
   One UE or TRP transmits a RS-RR
   The RS-RR is received by several devices
   Several devices (e.g. roadside units (RSU) or other UEs) may respond
   If several devices respond to a first device, the devices may use orthogonal sequences (different COMB offset, different cyclic shifts) or sequences selected according cross correlation properties (different sequence ID, for example)
Periodic or semi-persistent measurements may be configured (e.g. defined by the measurement update rate) or a single set of measurement (aperiodic) is configured
   A aperiodic measurement set may include several RS-RR sets to increase the accuracy by averaging, for example.

The RS configuration is determined by the network (if UE is in coverage) or another UE (if the sidelink is used for the measurements) and/or wherein the RS configuration is transmitted by the network, the base station, the gNB based on request of the first and/or second apparatus.

In the above embodiments it has been described that the first and the second reference signals as well as the third and the fourth reference signals, respectively, form a double burst signal. They may be out of the group
DL-PRS
SRS
CSI-RS
DM-RS.

According to embodiments, the measurement is performed based on one of the following principles:
Measurement of the phase or phase change of a single sub-carrier
Averaging over the phase or phase change of several sub-carrier
Calculate the correlation of the transmit and receive signal and report the phase of the correlation “lobe” related to the first arriving path.

According to embodiments, a report is transmitted. The report can comprise at least one of the following measurements
Phase of the received signal
Difference of the phase (example: D1 calculates the range. D2 reports the measurement of the phase on the signal received from D1 and reports back the phase difference (d_{φ1} in the example)
Other data (The reports and related measurements are not in the scope of this invention, but the new reports may be added to existing reports), like RTT measurements, signal quality information or beam information.

Another embodiment provides another apparatus, e.g., being the second apparatus (advantageous) or the first apparatus. Another apparatus comprises a transceiver and is configured to communicate to a first apparatus which transmits a first reference signal at a first point of time and at least a second reference signal at a second point of time to the second apparatus. Analogously, the first and the second reference signals belong together so as to form a first set, also referred to as double burst forwarding. The second apparatus is configured to receive the first and the second reference signal in order to calculate a first phase difference d_{φ1} between the first and the second reference signal. d_{φ1}=angle(RS_{22,RX})−angle(RS_{21,RX}). Additionally or alternatively, the second apparatus can report the first phase difference d_{φ1} or the angle (RS_{22,RX}) and the angle (RS_{21,RX}) to another entity by the first apparatus or the LMF. The second apparatus is configured to transmit a third reference signal at a third point of time and at least a fourth reference signal at a fourth point of time in response to the first and second reference signal to the first apparatus. The third and the fourth reference signals form a second set, also referred to as double burst return link. This has the purpose to calculate a second phase difference d_{φ2} between the third and the fourth reference signals and/or to report the second phase difference d_{φ2} or the angle (RS_{12,RX}) and the angle (RS_{11,RX}) to another entity, like the second apparatus or the LMF. Based on d_{φ1} and d_{φ2} or based on the formula d_{φMovement}=(d_{φ1}+d_{φ2})/2 a distance, a distance change and/or a relative speed of a first and second apparatus is calculable. As discussed above, the calculation may be performed by the first and second apparatus (UEs) or another entity, like the LMF.

Just for the sake of completeness, it should be mentioned that the apparatus may comprise one of the following: a user equipment, mobile device, smartphone, smart device, IoT device, vehicle, road side unit, non-terrestrial component, drone, satellite, gNB, NG RAN node, IAB node, TRP, LMF. Here, the first apparatus as well as the second apparatus may be formed by one of the said apparatuses.

Another embodiment provides a positioning system comprising at least a first apparatus and a second apparatus. The two entities interact together for the positioning. Additionally, the positioning system may comprise an LMF. According to embodiments, the LMF may be configured to receive a report from one of the apparatuses and/or may be configured to initiate a phase measurement performed by the first and/or second apparatus. Additionally or alternatively, the LMF may be configured to calculate a distance and/or a distance change and/or a relative speed of the first and/or second apparatus. For this, the LMF may also perform the calculation of the phase difference.

Another embodiment provides a method for performing position determination performed by a first apparatus. The method comprises the following steps:

transmitting a first reference signal at a first point of time and at least a second reference signal at a second point of time (first and second reference signal also referred to as double burst forward link) to a second apparatus

so that the second apparatus receives the first and the second reference signal in order to calculate a first phase difference d_{φ1} (d_{φ1}=angle(RS_{22,RX})−angle(RS_{21,RX})) between the first and the second reference signal and/or to report the first phase difference d_{φ1} or the angle(RS_{22,RX}) and angle(RS_{21,RX})) to another entity, like the LMF, to the first apparatus;

receiving from the second apparatus a third reference signal at a third point of time and at least a fourth reference signal at a fourth point of time (third and fourth reference signal also referred to as to double burst return link) in response to the first and second reference signal

in order to calculate a second phase difference d_{φ2} (d_{φ2}=angle(RS_{12,RX})−angle(RS_{11,RX})) between the third and the fourth reference signal, and/or to report second phase difference d_{φ2} the angle(RS_{12,RX}) and angle(RS_{11,RX})) to another entity, like the LMF, or to the second apparatus;

wherein a distance or distance change and/or a relative speed (v) of the first and the second apparatus is calculable based on d_{φ1} and d_{φ2} or based on the formula d_{φMovement}=(d_{φ1}+d_{φ2})/2. Note d_{φ1} is the first phase difference between the signals transmitted by the first transmitter, d_{φ2} is the second phase difference between the signals transmitted by the second transmitter.

Another embodiment provides another method for performing position determination performed by a second apparatus. The method comprises:

receiving a first and at least a second reference signal transmitted by the first apparatus, the first reference signal is transmitted at a first point of time and the second reference signal is transmitted at a second point of time (first and second reference signal also referred to as double burst forward link) in order to calculate a first phase difference d_{φ1} (d_{φ1}=angle(RS_{22,RX})−angle(RS_{21,RX})) between the first and the second reference signal and/or to report the first phase difference d_{φ1} or the angle(RS_{22,RX}) and angle(RS_{21,RX})) to another entity, like the LMF, to the first apparatus;

transmitting a third reference signal at a third point of time and at least a fourth reference signal at a fourth point of time (third and fourth reference signal also referred to as to double burst return link) in response to the first and second reference signal to the first apparatus

in order to calculate a second phase difference d_{φ2} (d_{φ2}=angle(RS_{12,RX})−angle(RS_{11,RX})) between the third and the fourth reference signal, and/or to report second phase difference d_{φ2} the angle(RS_{12,RX}) and angle(RS_{11,RX})) to another entity, like the LMF, or to the second apparatus;

wherein a distance or distance change and/or a relative speed (v) of the first and the second apparatus is calculable based on d_{φ1} and d_{φ2} or based on the formula d_{φMovement}=(d_{φ1}+d_{φ2})/2. Note RS_{22,RX} represent the 2nd burst signal received by the second receiver (i.e. the second signal according to the claim wording), where RS_{21,RX} represent the 1st burst signal received by the second receiver (i.e. the first signal according to the claim wording). Vice versa, RS_{12,RX} represent the 2nd burst signal received by the first receiver (i.e. the fourth signal), where RS_{11,RX} represent the 1 nd burst signal received by the first receiver (i.e. the third signal).

According to another embodiment, the position determination may comprise the steps of both of the previously discussed methods.

According to another embodiment, the method may additionally comprise one of the following steps:
Exchange DL-PRS configuration information on NRPPa;
Exchange information on performing capability;
Performing on-demand PRS procedure;
Transferring assistance data;
Requesting location information;
Performing UE measurements;
Providing location information;
Requesting NRPP a positioning information (i.e. Requesting SRS
configuration from NG-RAN node hosting the serving cell);
gNB determines UL SRS resources;
Providing the SRS configuration to the UE;
Positioning information response;
Activation of SRS;
Requesting NRPPa measurement (i.e. making request to several
TRPs to measure the uplink SRS);
Measuring UL-PRS (e.g. SRS);
Responding by reporting positioning measurement over NRPPa;
Performing LMF processing.

Just for the sake of completeness, it should be noted that another embodiment refers to a computer program for performing, when running on a computer, one of the above discussed methods.

According to embodiments, the first and second reference signal as well as the third and fourth reference signal, i.e., the double burst forward link and the double burst return link is configured by a configuration information. This configuration information may be output by a LMF a base station or an apparatus. The configuration information may comprise information on resources, e.g., two resources for the first and second reference signal within one slot or two resources for the third and fourth reference signal within a slot. Additionally or alternatively, the configuration information may comprise information on the first, second, third and/or fourth point of time. A time period between the first and second reference signal and/or the third and fourth reference signal may be configured. Additionally, a time period between the two double burst signals, i.e., between the second and third reference signal may be configured. Advantageously, this period is smaller than the measurement period.

According to embodiments another measurement using another double burst signal, e.g., another double burst return signal may be used. Therefore,—according to an example—another UE within the same cell or a neighboring cell may output another double burst signal, another double burst return signal, so that another measurement can be performed. This increases the accuracy.

According to embodiments, the time difference between the first and the second double burst signal (double burst forward link and double burst return link) may be used for calculating a distance change and/or a relative speed. For example, the first double burst signal has a duration of 1 ms unless, wherein the second double burst signal has also a duration of 1 ms, wherein a pause/time difference between the first and second double burst signal amounts to approximately 100 ms. The deviation of the time difference between the second and the first double burst signal from the idle time period (100 ms time period) enables a calculation of the distance change and/or relative speed. According to embodiments, this principal can be improved, when the first devices operate synchronously. According to embodiments, the first and/or the second device may be a stationary signal or may be configured by stationary entity (LFM or base station), so that the first and second double burst signal is synchronously transmitted to each other.

### BRIEF DESCRIPTION OF THE DRAWINGS

Embodiments of the present invention will be detailed subsequently referring to the appended drawings, in which:

FIG. 1 shows a schematic block diagram illustrating car-to-car distance measurement as example application of embodiments;

FIG. 2 shows a schematic diagram illustrating reference signal timing to illustrate embodiments;

FIG. 3 shows one RB (Resource Block) of a slot containing a DL-PRS considering parts of a DL-PRS as double burst signal/reference signal;

FIG. 4 shows schematically an implementation of double burst by a single SRS as a reference signal according to further embodiments;

FIGs. 5a and b show an example for the resulting frequency response (channel UMI-loss) to illustrate further embodiments;

FIG. 6 shows schematically a time domain measured channel impulse response to illustrate further embodiments;

FIG. 7 shows a schematic IQ diagram depicting the complex valued correlation function according to further embodiments;

FIG. 8 shows schematically a call flow diagram in NG-RAN allowing multi-RTT with double phase difference according to embodiments;

FIG. 9 shows schematically a depiction of wideband DL-PRS with low periodicity and narrowband DL-PRS pairs with higher periodicity to allow lower update rate of coarse range and higher update rate of finer range according to further embodiments;

FIGS. 10a and b show schematic representation of an example of a wireless communication system;

FIG. 11 shows a schematic representation of an in-coverage scenario in which two UEs directly communicating with each other are both connected to a base station;

FIG. 12 shows a schematic representation of an out of coverage scenario in which the UEs directly communicate with each other;

FIG. 13 shows an example of a computer system on which units or modules, as well as the steps of the methods described in accordance with the inventive approach, may be executed.

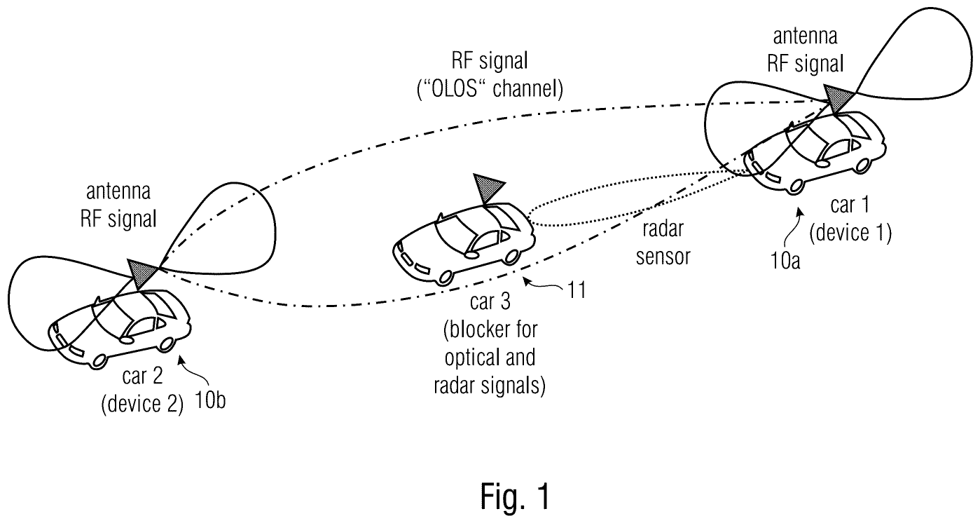

### DETAILED DESCRIPTION OF THE INVENTION

Below, embodiments of the present invention will be discussed with referring to the enclosed figures, wherein identical reference numerals are provided to objects having identical or similar functions, so that the description thereof is mutually applicable and interchangeable.

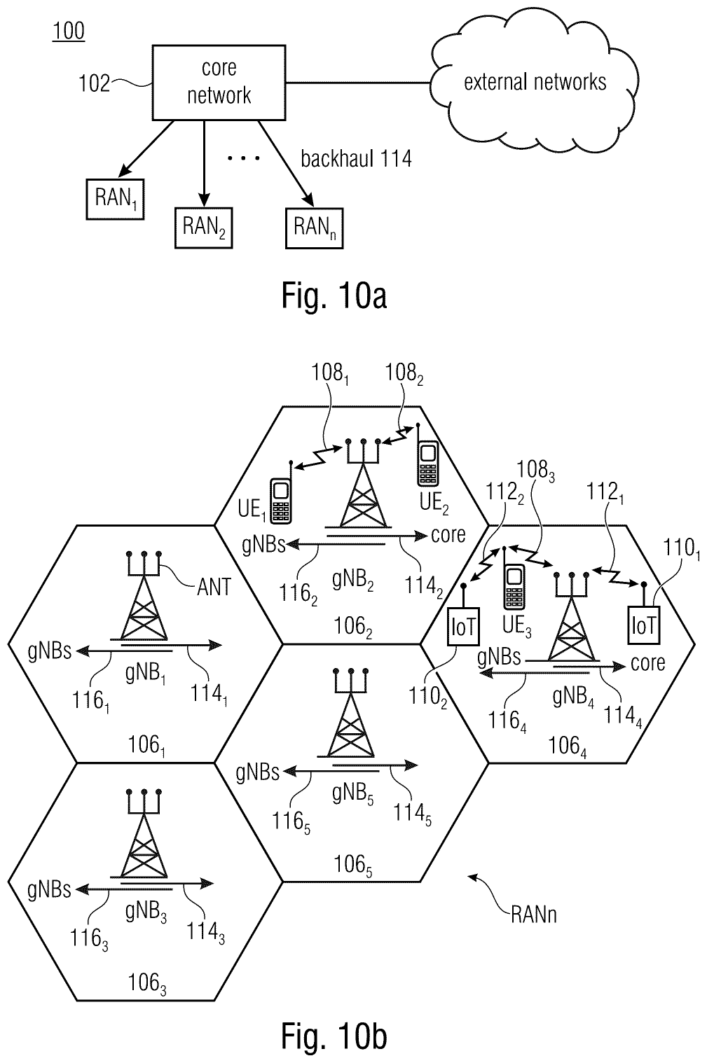

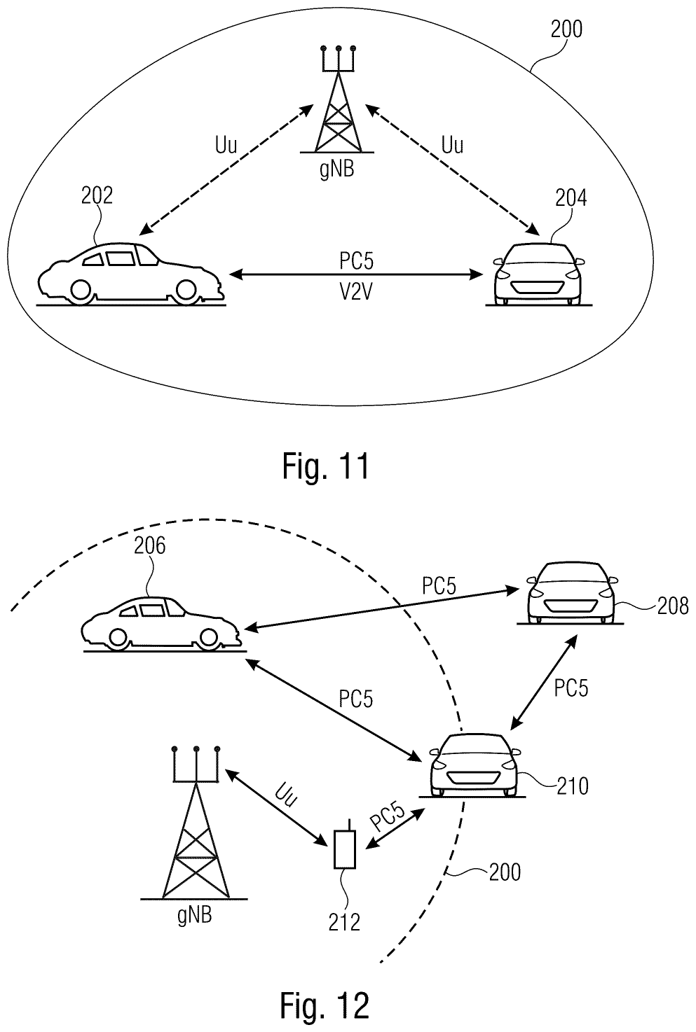

For a wireless communication system or network as described above with reference to FIG. 10, 11 or 12 have the main purpose to perform communication. However, for the communication itself and/or for a plurality of applications used by the user equipment (in general apparatuses) position determination is a central task. The signals/communication signals exchanged between the UEs can be used to perform measurements so as to determine a distance, distance change and/or velocity.

Below, an approach according to embodiments will be discussed which enables high accuracy and low latency for position determination.

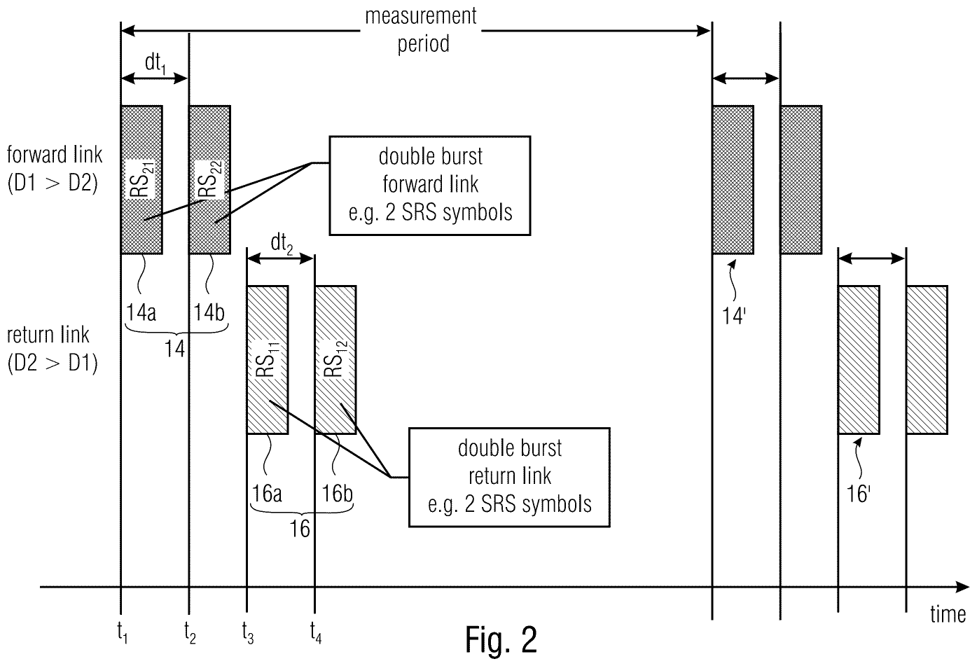

The below embodiment starts from the assumption that two UEs (in general first apparatus 10a and second apparatus 10b) exchange signals, here reference signals. In detail, the first apparatus 10a outputs a first forward link having the shape of a double burst 14, wherein the second apparatus 10b output a return link signal having also the shape of a double burst 16. As is illustrated by FIG. 2, the return link signal 16 is transmitted in response to the received forward link signal 14.

FIG. 2 shows a diagram illustrating a measurement period when the forward link 14 as well as the return link 16 is used. The forward link represents a transmission from device 1 to device 2, wherein the return link represents a transmission from device 2 to device 1 (device 1=10a, device 2=10b). As can be seen, each signal 14 and 16 has a double burst shape. Therefore, it is also referred to as double burst forward link, e.g., two SRS symbols transmitted at two subsequent points of time t1 and t2 with or without having a time gap in between. The two double burst signals are marked by reference numeral 14a for the signal transmitted at t1 and 14b for the signal transmitted at t2. The return link also has the shape of a double burst signal, thus it is referred to as double burst return link, e.g., two SRS symbols. The two signals 16a and 16b of the double burst return link 16 are transmitted subsequent to each other at the points of time t3 and t4 with or without having a gap in between. The transition points t1 and t2 have a gap of dt₁, wherein the transmission points t2 and t4 have a gap of dt₂.

Below, a possible calculation for using the signals 14a, 14b, 16a and 16b, also referred to as RS₂₁, RS₂₂, RS₁₁ and RS₁₂ will be discussed.

To distinguish the phase change caused by frequency offset and by distance change a “double phase difference method” is proposed, characterized by:
1. Devices 1 (D1) transmits a reference signal (RS₂₁) useful for phase measurement at the time t₁
2. At t₂ a second reference (RS₂₂) signal is transmitted. The time dt₁=t₂−t₁ is selected taking into account the expected frequency offset range between D1 and the device 2 (D2).
3. D2 receives the signal and calculated the phase difference

$$d {φ}_{1} = angle ( {RS}_{22 , RX} ) - angle ( {RS}_{21 , RX} )$$

4. D2 transmits also a double burst (RS₁₁ and RS₁₂) towards D1 at the time t₃ and t₄. For simplicity reasons in this example it is assumed that the difference dt₂=t₄−t₃ is nearly identical to dt₁. Only a minor (e.g 1 ppm→dt₂ =dt₁*(1+/−1*10⁻⁶) difference according to the frequency offset is assumed.
5. D1 receives the signal and calculates the phase difference

$$d {φ}_{2} = angle ( {RS}_{12 , RX} ) - angle ( {RS}_{11 , RX} )$$

6. Assuming a frequency offset between the center frequencies of the devices D1 and D2 is

$${df}_{1} = {fc}_{D 1} - {fc}_{D 2}$$

the expected phase difference is

$$d {φ}_{1} = {2}^{*} {π}^{*} {{df}_{1}}^{*} {dt}_{1} + d {φ}_{Movement}$$

where d_{φMovement} represents the phase change resulting from the distance change
7. Assuming the center frequencies of both devices do not change during the measurements for forward and return link the effective frequency offset is

$${df}_{2} = {fc}_{D 2} - {fc}_{D 1} = - {df}_{1}$$

and assuming dt₂=dt₁

and assuming the speed has not changed, the expected phase change is

$$d {φ}_{2} = - {2}^{*} {π}^{*} {{df}_{1}}^{*} {dt}_{1} + d {φ}_{Movement}$$

8. Calculating the sum of d_{φ1} and d_{φ2} gives

$$d {φ}_{Movement} = ( d {φ}_{1} + d {φ}_{2} ) / 2$$

9. From d_{φMovement} the distance change dd and relative speed v between D1 and D2 can be calculated. 2* 7 (or 360 degree) corresponds to the wavelength A. Hence, the distance change is

$$dd = - d {φ}_{Movement} / {( {2}^{*} π )}^{*} λ$$

and the relative speed is

$$v = dd / {dt}_{1}$$

10. The frequency offset can be calculated using the difference of d_{φ1} and d_{φ2}.

This removes the impact of the movement.

$$df = {df}_{1} = - {df}_{2} = ( d {φ}_{1} - d {φ}_{2} ) / ( {4}^{*} {π}^{*} {dt}_{1} )$$

If a configuration with dt₁≈dt₂ is used, the formulas can be adapted accordingly.

A possible method is (please note the “′” in the formula):

The d_{φ2}′=angle(RS_{12,RX})−angle(RS_{11,RX}) measured by D1 is representing

$$d {φ}_{2}^{′} = - 2 * π * {df}_{1} * {dt}_{2} + d {φ}_{M ovement}^{′}$$

normalized by

$$d {φ}_{2} = d {φ}_{2}^{′} ⋆ {dt}_{1} / {dt}_{2} .$$

In this case the formulas (8) to (10) given above remain identical. Obviously, other methods (normalize d_{φ1}′ , for example) are possible also.

It should be noted, that unless mentioned the above steps are not necessarily performed in the provided order. In some examples the first device and second can have a coordinated transmission which can be configured within the same or different periodic configurations between D1 and D2.

The exchange of the signals RS₂₁, RS₂₂, RS₁₁ and RS₁₂ (14a, 14b, 16a, 16b) are done during the measurement time interval. After this measurement time interval, a further measuring time interval may follow. This further measurement time interval may also use double burst forward link 14′ and double burst return link 16′. The measurement time intervals may be periodically repeated.

According to embodiments, the first apparatus/first UE 10a transmitting the signals 14, 14a and 14b as well as the second apparatus/second UE 10b transmitting the signals 16, 16a and 16b are configured by use of an RS configuration. The RS configuration may, for example, be provided by the LMF or by the gNB. The mentioned entities may provide the RS configuration in the in-coverage scenario. In the out-of-coverage scenario, one of the UEs, e.g., the first UE, may have information on the RS configuration, e.g., pre-configuration and can provide the RS configuration to the other entities.

The RS configuration may comprise an information on the resources to be used. The transmit (further called RS-RR (=reference signal for relative range)) is characterized by the following parameters and properties or at least by one of the following parameters and properties:
Measurement update rate (measurement period). Note: Application using a single measurement (measure current relative speed) or an on-demand measurement (measurement update rate is not constant) may be also possible. In this case the measurement period may be not set or set to a value indicating “single measurement only” or on demand measurement (triggered by other messages or events, for example).
Number of RS-RR transmissions related to one measurement (2 or more RS signal transmission per direction). For one set of measurements a “RS-RR set” can be defined. The number of RS-RR per direction may be different.
The “RS-RR set” is defined by
   Time difference between the RSs belonging to one set (dt₁ and dt₂).
   Bandwidth of the RSs (complete carrier bandwidth or part of it)
   Other parameter of the RSs (sequence ID, COMB-factor, COMB offset, cyclic shift, . . . )
   Number of OFDM symbols per RS (one or more)
   Maximum time difference between the start of the RS for forward link and return link (difference between t₃ and ti)
dt₁ and dt₂ is selected according the frequency offset range and the speed range. If more than 2 symbols are transmitted per direction the dt₁ and dt₂ may be a vector including several values or the distance per direction is identical for all symbols.
The difference between t₃ and t₁ is not critical and is selected according to the frequency stability.
   The return link may transmit after receiving the forward link signal: t₃ >t₁ and t₃ >t₂
   Interlaced: t₃ >t₁ and t₃<t₂
   The return link may transmit before the forward link: t₃<ti
Several UEs may respond to one UE, e.g.
   One UE or TRP transmits a RS-RR
   The RS-RR is received by several devices
   Several devices (e.g. roadside units (RSU) or other UEs) may respond
   If several devices respond to a first device, the devices may use orthogonal sequences (different COMB offset, different cyclic shifts) or sequences selected according cross correlation properties (different sequence ID, for example)
Periodic or semi-persistent measurements may be configured (e.g. defined by the measurement update rate) or a single set of measurement (aperiodic) is configured.
   A aperiodic measurement set may include several RS-RR sets to increase the accuracy by averaging, for example.

According to embodiments, the UE(s) may receive all configuration parameters from the network (method is used for UE⇔TRP or for UE⇔UE (=sidelink (SL)). If SL and UE is in coverage of a gNB: The network may define the time-slot allowed for SL usage and a first UE sends the configuration to a second UE.

For example, the UE may request from the network slots for the RS-RR transmissions. If OOC (out-of-coverage), one UE configures other UEs.

Below, embodiments of RS signal generation will be discussed. The “double burst” RS may be a new RS signal type based on existing RS. The 3GPP NR standard supports already several RS, for example:
DL-PRS
SRS
CSI-RS
DM-RS

Thus, according to different embodiments, different reference signals or a combination of different reference signals may be used. It should be noted that the RS signal is not limited to those types.

In principle each of these signals can be used as RS-RR or any combination of it.

Optionally, a new type of reference signal (“RS-RR”) is defined with the characteristics as defined in FIG. 2. It shall be noted that the 2 signals implementing a “double burst” can be also different to each other. The second (or further) symbol may use
A different bandwidth
A different COMB factor
A different COMB offset
A different cyclic shift

Below, the use of the DL-PRS as a reference signal will be discussed in detail.

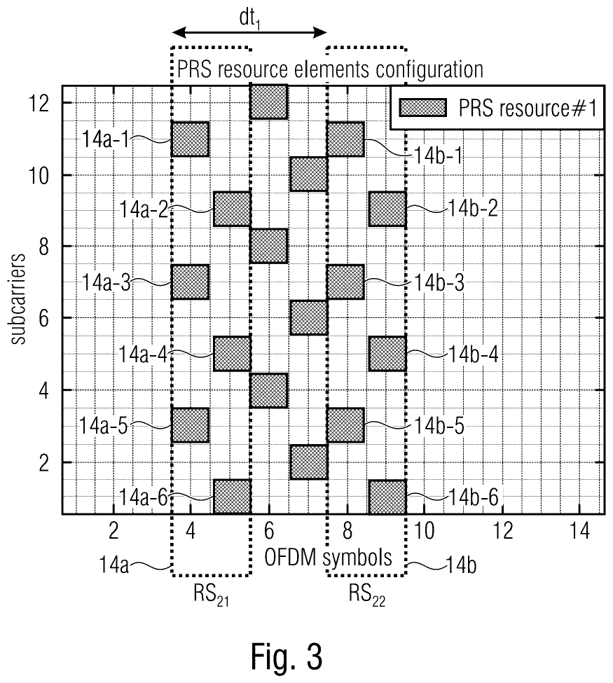

According to an embodiment, the DL-PRS includes several OFDM symbols (e.g., 6). On each OFDM symbol a phase measurement can be performed. “dt₁” is implemented to report the phase of different OFDM symbols. An example is given in FIG. 3. The 4^{th} and 5^{th} OFDM symbol of a slot containing the first two OFDM symbols of the DL-PRS represent RS₂₁, the 8^{th} and 9^{th} OFDM symbol of the slot containing the 5^{th} and 6^{th} OFDM symbol of the DL-PRS is considered as RS₂₂. The resulting dt₁ is equivalent to the duration of 4 OFDM symbols in the example.

FIG. 3 shows different resources using a diagram plotting different subcarriers over a plurality of OFDM signals. As can be seen, a reference signal, here the reference signal RS₂₁ and RS₂₂ representing the double burst signal 14a and 14b are formed by a plurality of PRS resources marked by 14a_1 to 14a_6 and 14b_1 to 14b_6. As can be seen, 14a_1 to 14a_6 comprise six resource portions each defined by a combination of a subcarrier and a respective OFDM symbol. For RS₂₁ two different symbols and six different subcarriers are used. The shown pattern may be repeated for all RBs assigned to the DL-PRS to form a wideband signal. The same holds true for RS₂₂, which also uses two different symbols (different from the symbols of RS₂₁) as well spread over six subcarriers. The carriers are not directly abutted to each other, but this could be according to a further embodiment. Although FIG. 3 just shows a double burst forward link signal, this description may also represents a description of a double burst return link signal.

Below, the use of a second DL-PRS signal according to further embodiments is described. Release 17 may support “on-demand” DL-PRS. These additional DL-PRS may be scheduled to fulfil the characteristics of the double bursts as defined above.

According to another embodiment SRS and/or one resource may be used as a reference signal.

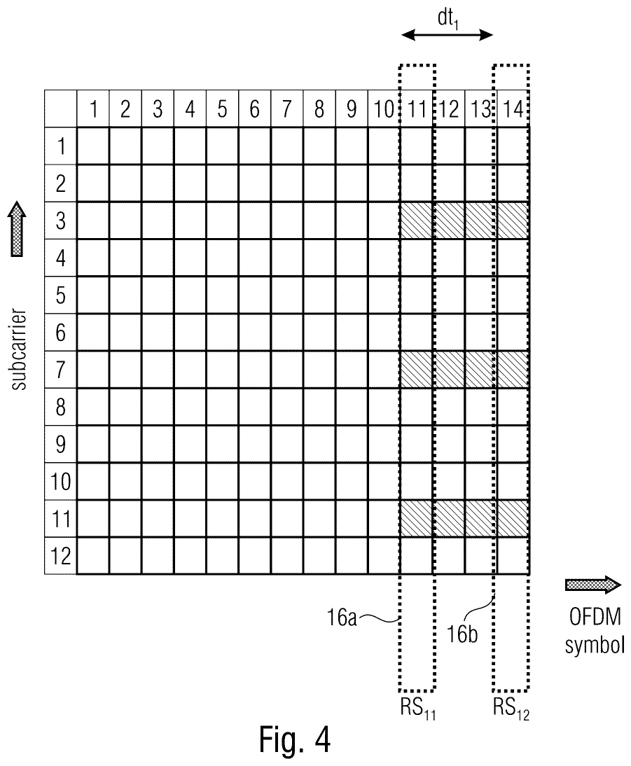

The 5G standard supports SRS occupying several OFDM symbols. Repetition or staggering can be applied 2. If the SRS uses several OFDM symbols the measurements can be performed on each OFDM symbol. By reporting the phase or phase difference for the different OFDM symbols of the SRS the “dt₁” can be defined. In the example depicted in FIG. 4 (SRS with repetition) the duration of 3 OFDM symbols is selected as dt₁

FIG. 4 shows a diagram plotting subcarriers over OFDM symbols to illustrate a double burst signal comprising the two bursts RS₁₁ (equivalent to 16a) and RS₁₂ (equivalent to 16b). As can be seen, the signal RS₁₁ comprises a plurality of resource portions, here resource portions spread over multiple subcarriers, here three subcarriers per RB. The symbol for RS₁₂ is the same. The signal RS₁₂ transmitted after dt₁ also comprises multiple resource portions (here three) spread over three subcarriers per RB. The REs of the OFDM symbols used by the RS may be the same for all four OFDM symbols. The resource elements used for the RS-RR are marked as hashed fields. As can be seen, between the used carriers (REs) of the resource blocks forming RS₁₁ and RS₁₂ other carriers (REs) may be arranged, wherein, this other REs may include other data or other RS. Although the SRS signal has just been discussed in the context of RS₁₁ and RS₁₂, it should be mentioned that the SRS signal used for RS₂₁ and RS₂₂ may be comparable.

The 5G standard allows that a device is configured to transmit several SRS resources. The SRS resources may be placed at different positions in a frame. Using two or more resources phase difference between the SRS resources can be measured and reported.

Below, the RS measurement as well as the use reporting will be discussed in detail. According to embodiments, the receiving devices measures the phase of the received RS-RR. Different methods for the phase measurement are considered
Measurement of the phase of a single sub-carrier
Averaging over the phase of several sub-carrier
Calculate the correlation of the transmit and receive signal and report the phase of the correlation “lobe” related to the first arriving path
   Remark: For bandwidth limited signals the “peak” may become a “lobe”. The lobes of the correlation function may be an overlap of several peaks according to the channel impulse response (CIR). The phase related to the “first arriving path” may be therefore measured at a position of the correlation function representing the estimated time-of-arrival (ToA) of the first arriving path.
   The measurement unit may evaluate the correlation function and may determine a estimate for the FAP (first arriving path) and may report the phase related to the FAP.
reporting of “raw data” (=complex valued correlation function) and phase calculation is done by the entity receiving the report] Instead of reporting the phase related to the FAP, the measurement unit may report the complete correlation function or parts of it (e.g. the part around the expected FAP).

Note, just one measurement of the above mentioned or a comparable phase measurement may, according to embodiments, be used.

Furthermore, according to further embodiments, a combination of one of the above measurements or a plurality of the above measurements with another measurement method may be used as well.
According to the simplest implementation a phase of the received signal is reported. According to further embodiments, a difference of the phase may be reported. Example: D1 calculates the range. D2 reports the measurement of the phase on the signal received from D1 and reports back the phase difference (d_{φ1} in the example).

Optionally other data may be reported, e.g., at least one of the following
RTT measurements: ToA_{D2} (time of arrival measured relative to the clock of D2 for the RS received by D2 for the RS transmitted by D1 and ToT_{D2} (time of transmit measured relative to the clock of D2 for the RS transmitted back to D1 by D2). Note: This reporting procedure is state-of-the-art for “RTT measurements”
Signal strength information
Beam information (characteristics of the effective antenna pattern, selected beam)

According to embodiments, the phase management concept may be as follows:

One possible method for the phase measurement is the “cyclic correlation”. The receiver detects the start of the OFDM symbol
The received signal is transformed into the frequency domain using a FFT.
In the frequency domain signal is multiplied with the conjugate complex value of the FFT of the transmitted OFDM symbol (without cyclic prefix).

$$FR = FFT ( x ( {n}_{0} + n ) ) * conj ( FF T ( ref ( n ) ) )$$

with
x represents the input signal
n₀ is the derived from the OFDM symbol timing recovery and represents the time when the OFDM symbol (after cyclic prefix removal) starts
ref is the transmitted signal
n=[0.. (fftlength-1)]

Note: If the transmitted signal does not have constant magnitude per subcarrier versus frequency the magnitude frequency response of the transmit signal is to be taken into account for the frequency response measurement. In the example we use a SRS with constant magnitude of all subcarriers. In this case the multiplication of FFT(x(n₀+n) ) with conj(FFT (ref(n) ) gives the frequency response.

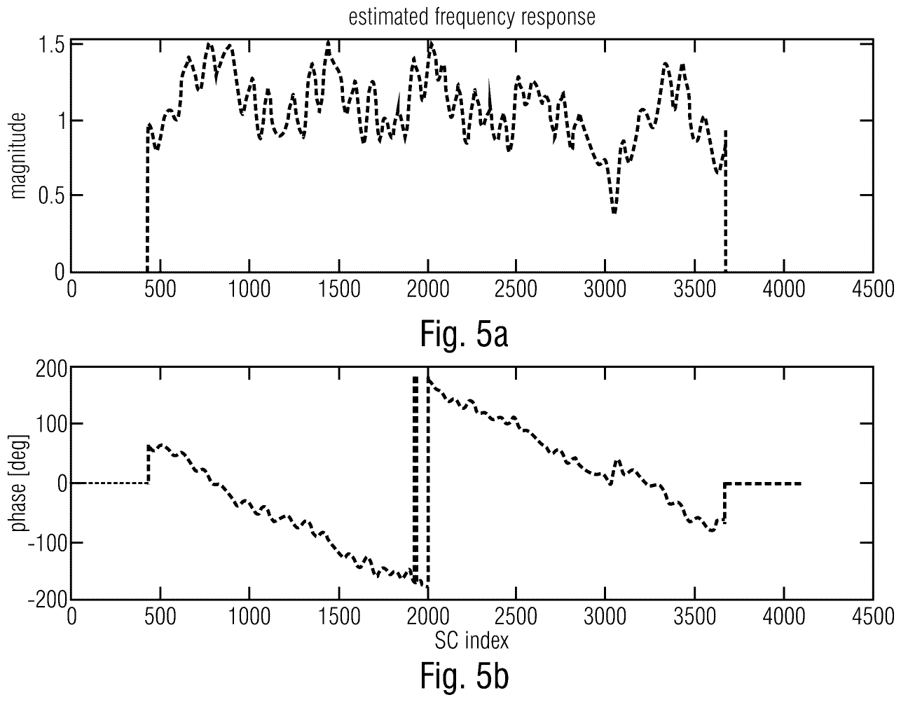

FIG. 5a shows a magnitude diagram and 5b shows a phase diagram of an estimated frequency response. Both diagrams 5a and 5b are plotted over the subcarrier (SC) index.

In principle the phase can be derived from the frequency response. But multipath an delay have a high impact to the phase. Alternatively the phase can be derived from the correlation function in the time domain.

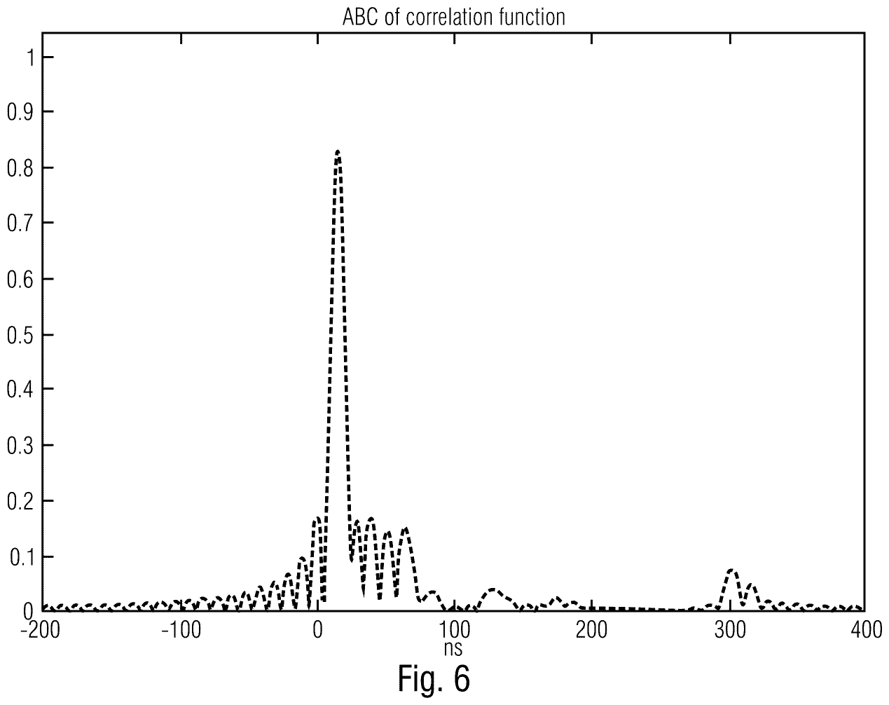

By calculating the IFFT of the frequency response the channel response in the time domain (FIG. 6) results. Note: The figure shows the measured channel response relative to the FFT window position.

FIG. 6 shows a time domain measured channel impulse response (magnitude) to illustrate a possible ABS of correlation function.

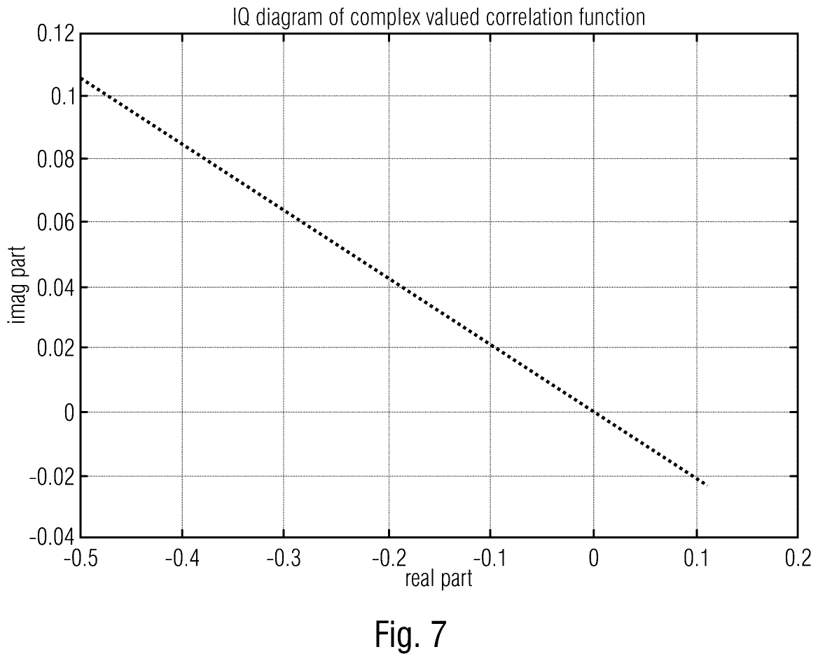

Instead of measuring the phase in the frequency domain, the phase can be derived from the complex valued correlation function. FIG. 7 shows the correlation function as “IQ-Diagram” of the correlation function:
The x-axis represents the real part of the calculated correlation function
The y-axis the imaginary part of the calculated correlation function

The angle of the correlation peak represents the phase of the received signal. FIG. 7 shows the “IQ-diagram” for a channel with no/minor multipath components. In this case the correlation functions in the IQ-diagram is a “needle”. The angle of the needle represents the phase. In case of multipath the IQ diagram may no-longer a needle. The phase may be read out at the correlation functions sample representing the first arriving path (FAP).

According to another embodiment, UE gNB measurements, i.e. a measurement procedure performed between the UE and gNB (general base station) may be used. As described above, a correlation function may be used as basis for the phase measurement.

If the correlation is performed for signal optimizing of auto-correlation properties, the correlation functions represent an estimate of the channel (impulse) response.

According to embodiments, additional or alternative measurements as proposed for 3GPP may be used.

According to embodiments, a UE DL-PRS phase measurement may be used. Here, the gNB transmits a DL-PRS so that the UE performs the measurement.

The measured phase DL-PRS is defined as the phase of a received path of the channel response from the DL-PRS signal, wherein the path corresponds to the first detected path by the UE.

According to further embodiments, UE DL-PRS phase difference type-1 measurements may be used. Here, a phase difference in time is measured.

The measured phase DL-PRS difference is defined as the phase difference of the phase of a received path of the channel response from the same DL-PRS signal over multiple time intervals, wherein the path corresponds to the first detected path by the UE in each time frame.

According to further embodiments, UE DL-PRS phase difference type-2 may be used. Here, a difference of the phase of the signal received from different devices can be measured.

The measured phase DL-PRS difference is defined as the phase difference of the phases of a received path of the channel response from a first DL-PRS signal obtained from the first node and the phase from a second DL-PRS signal obtained from the second node, wherein the path corresponds to the first detected path by the UE in each time frame.

It should be noted that if several antenna ports are used (e.g. transmitting device sends different signals over 1 or more transmit ports, and receiving device receives the signal(s) over 1 or more receive ports ) the phase may be reported for each antenna pair or averaging may be applied. If averaging is applied the difference (or standard deviation) of the phase difference of the measurements performed on different pairs are an indicator for the multipath characteristics. Hence the difference between the phase measured for different pairs may be relevant. For antenna arrays this difference can be used to estimate the angle of departure (AoD) or angle of arrival (AoA).

Possible definition of angle: the angle (RS_{22,RX}) is defined as being dependent or equal to the phase; for example, the phase is defined by a measured angle/phase in the frequency domain at one or more carried or in time domain from a received path of the channel response from the RS signal, wherein the path corresponds to a given path which can be the first detected path by the UE; alternatively, the phase is derived from a IQ report of a single or multiple paths.

Note the phase measurements may be translated to frequency measurements; and/or where the phase/angle is represented as a change in frequency given by

$$df\_x = ( 1 / 2 pi ) * ( d φ x / dtx ) .$$

According to further embodiments, UE DL-PRS phase difference type-3 may be used. Here, the difference of the phase of the signal received using different antenna ports is measured. If several beams (or antenna ports) are used the type-3 phase difference represents the phase difference between different beam pairs.

According to another embodiment, UE DL-PRS phase for an additional path may be used. The measured phase DL-PRS is defined as the phase of one or more received paths of the channel response from the DL-PRS signal, where the paths correspond to the paths different from the first detected path by the UE.

Note1: For frequency range 1, the reference point for the DL-PRS Phase shall be the antenna connector of the UE. For frequency range 2, the reference point for the DL-PRS Phase shall be the antenna of the UE or the Rx antenna (i.e. the centre location of the radiating region of the Rx antenna).

Note2: The above UE measurements are applicable to sidelink by using instead of the DL-PRS a SRS for the forward link also or a new sidelink specific reference signal (SL-RS).

Signals a defined “NR: Physical channels and modulation V16.2. For Definite 38.305 is valid.

According to a further embodiment, gNB UL SRS phase may be measured. Here, the UE transmits while the gNB performs the measurement.

The measured phase UL SRS is defined as the phase of a received path of the channel response from the UL SRS signal, wherein the path corresponds to the first detected path by the TRP.

Similar to UE, we define gNB UL SRS Phase difference type-1/2/3, and Phase for additional path: The reference point for UL SRS Phase can be one of the following:
the Rx antenna connector,
the Rx antenna (i.e. the centre location of the radiating region of the Rx antenna),
the Rx Transceiver Array Boundary connector.

According to further embodiments, SL-RS phase may be measured. Here, D1 and D2 are the UEs transmitting the respective signals and performing the respective measurements. For RS signals transmitted over the sidelink (SL) the same signal type may be used for the forward link and the return link.

Below, procedures for performing measurements processing the phase measurements according to further embodiments may be described.

In the following, the signalling mechanisms and procedure for the proposed method is explained using call sequence for multi-RTT, described in TS 38.305, Rel. 16 adapted for the proposed method. The following diagram shows a possible sequence of actions to determine UE location using multi-RTT enhanced with double phase measurements. In this example, we have steps involving downlink PRS first, followed by the steps involving uplink SRS. The sequences can however be carried out in a different order or two procedures can be simultaneously be carried out. Some of the information transfer procedures may also take place unsolicited, i.e. without explicit request from the counterpart. The selection of the method itself is subject to capabilities of the UE and/or TRP and/or the NG-RAN nodes involved in the UE positioning. As an example, the LMF may set a positioning session to perform positioning with multi-RTT and based on the obtained position and/or UE capabilities, the LMF may initiate a parallel positioning session where the UE is configured to use multi-RTT with double phase measurement.

In this example, DL-PRS is used as an example of downlink reference signal and UL-SRS is used as an example of uplink reference signal. In principle, any downlink reference signal can be combined with any another combination of uplink reference signal to achieve the same effect. In particular, CSI-RS in the downlink and SRS in the uplink, SRS in the forward link and SRS in the reverse link in case of sidelink, sidelink ranging signals defined in future in both directions for ranging between devices, use of demodulation reference signals on both links, synchronisation sequences and PRACH combinations and similar should also be assumed as feasible combination of reference signals.

Furthermore, if the RS (DL_PRS or SRS) contains more than one symbols within a resource, the reference signal transmitted in different symbols may be paired together to form reference signal pairs in one direction over which the phase is measured coherently. As an alternative to using two different resources within a resource set, the OFDM symbols within a resource can be partitioned to form different pairs. As an example, we consider a DL_PRS with 6 OFDM symbols. This can be considered as 3 pairs with a distance of 3 symbols, for example.
Pair 1: Symbol 1 and 4
Pair 2: Symbol 2 and 5
Pair 3: Symbol 3 and 6 For the uplink, the RS pairs for phase difference estimation can be formed as follows:
Two or more SRS resources within the resource set are indicated to the UE as pairs for coherent transmission.
One SRS resource with several OFDM symbols is configured and split in one or more pairs. For example, if an SRS symbol is 6 symbols, the first and the fourth symbol could form the pairs for phase measurements if the configured difference of separation is 4. Likewise, the second and fifth symbol could form pairs.
Any combinations of both

For sidelink, the RSs for positioning are not yet defined in the standard. To measure the phase change any of the RS transmitted in pair coherently may be used. For example, an SRS is transmitted by a UE may be measured by a second UE.

Likewise, SRS transmitted by the second UE in a different time could be received and measured by the first UE. The second UE need to be indicated over which two symbols, and/or two resources it measures the RS transmitted coherently by the first UE should be measured.

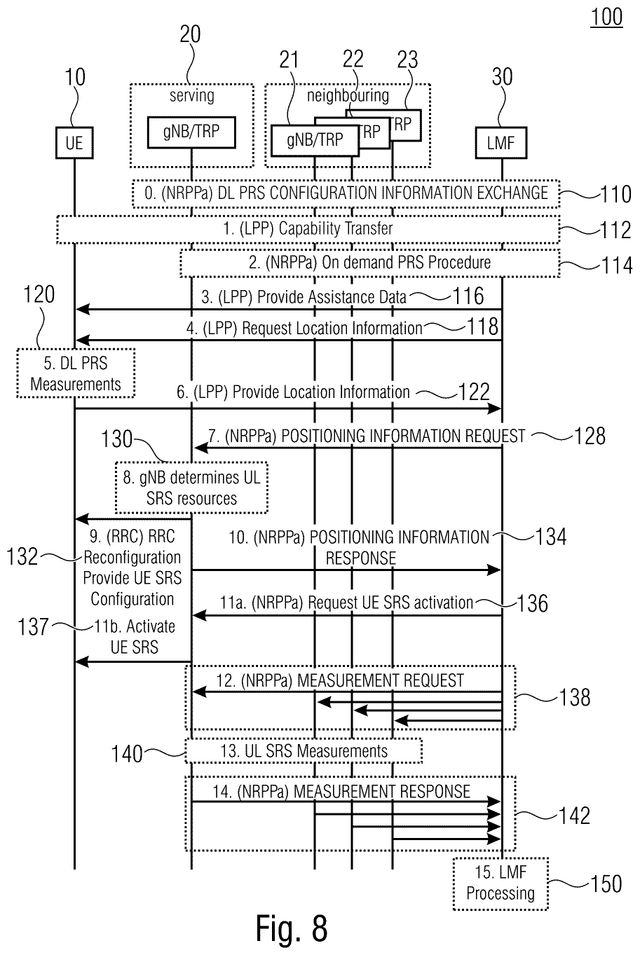

FIG. 8 shows a flow diagram in NG-RAN allowing multiple RTTs with double phase difference. As can be seen, the method comprises a plurality of steps, partially optional steps which are performed by different entities or the interaction of different entities. According to embodiments, the entity is UE 10, e.g., first apparatus and/or second apparatus, serving gNB/GLP 20 and LFM 30. Furthermore, neighboring gNB/GLPs may be in charge 21, 22, 23. The entire process is marked by the reference numeral 100, wherein the process comprises the steps 110, 112, 114, 116 for the configuration, 118 for the request and 120 for performing the downlink measurement and 122 for reporting the information on the downlink measurement. Here, the LMF 14 performs the step 118, while the downlink measurement 120 is performed by the UE 10 which reports in the step 122 local information. Then, the LMF 30 requests a normal measurement cf. step 128, so that the gNB can perform the uplink measurement 130. For this, an RFC reconfiguration For this an RRC reconfiguration providing UE SRS configuration may be performed, cf. step 132. In step 134, the position information response is provided by the element 20 in response to this information received by the LMF 30 an optional request for UE SRS activation 136 and 137 is provided/forwarded.

In response to the measurement request 138, the measurement 140 is performed and reported in the step 142. Based on this information (cf. step 122, 132 and 142) the LMF 30 can perform the processing in step 150.

The steps above are described in further details, highlighting the differences with the proposed approach compared to the state-of-the-art described in TS 38.305.

Step 0: NRPPa DL-PRS Information Exchange:

The LMF may acquire the DL-PRS configuration from at least one TRPs from at least one NG-RAN node to which the LMF has signalling connection. If the TRP has already indicated two resources that are transmitted coherently (or the resource uses a sufficient number of OFDM symbols), then the resources are provided as AD to the UE (in Step 3), wherein in the AD, the information indicating the UE that it can make phase difference measurements between two resources (or two parts of a resource) within the same occasion is indicated.

The LMF determines that certain TRP configuration information is desired (e.g., as part of a periodic update or as triggered by OAM) and sends a TRP INFORMATION REQUEST message via NRPPa to the gNB. This request includes an indication of which specific TRP configuration information is requested.

According to Rel. 16, the LMF may be request one or more information from the following: NR PCI, NR CGI, NR ARFCN, PRS Configuration, SSB Information, SFN Initialisation Time, Spatial Direction Information and Geographical Coordinates from one or more of the TRP hosted by the NW. During this state, the information that one resource has a phase coherent relation with another resource transmitted by the said TRP may be indicated to the LMF. This information may be extended as a part of PRS Configuration. One mechanism of indicating this is to add a field, phaseCoherentResourcelD and provide the ID of a second DL-PRS resource the said DL-PRS resource is phase coherent with. Alternatively, a list of phaseCoherentResourcelDs can be provided.

### Step 1: Capability Exchange:

The UE optionally informs a network node (e.g. LMF) and/or a second UE with which the UE is connected in sidelink its support of the feature of reporting phase measurements on downlink reference signals (for example DL-PRS) and/or on reference signals defined for device to device ranging (sidelink reference signals) and/or on uplink reference signals defined by the UE. Furthermore, the UE may also indicate to the network the bandwidth of the reference signal supported for phase measurement and reporting, its transmission capabilities on different band. The capability report may be requested by the network or it may be sent by the UE unsolicited.

Furthermore, the UE may indicate the expected accuracy of the carrier frequency recovery or the range of remaining frequency offset, respectively. Alternatively, this may also be indicated as a part of measurement report from the UE (for example: within the PROVIDE LOCATION INFORMATION message)

### Step 2: On-Demand PRS Procedure

If the LMF cannot identify two such resources for phase measurement for the downlink, then it may
1) Initiate an on-demand PRS procedure to request a second resource which is transmitted coherently with the first resource, where the on-demand PRS procedure consist of at least one of the following explicit parameters:
   a. Identifier of the DL-PRS resource with which the on-demand PRS is expected to be coherent with.
   b. The time-offset between the two resources. For example, such offset may be specified by specifying the start of the aforesaid existing DL-PRS and the start of the on-demand PRS.
   c. Explicit parameters defining the DL-PRS resource.
2) Initiate an on-demand PRS procedure to request two resources, which are coherently transmitted, wherein at least one of the explicit parameter within the DL-PRS resources is defined and at least the time-offset between the two resources.
3) The on-demand procedure may also indicate an existing DL-PRS resource used for range measurement, and insert one or more instants of two resources (coherent) and/or a single resource spanning multiple OFDM symbols between two occasions of the aforesaid DL-PRS resource for phase measurements.

During the on-demand PRS procedure, there may be several transactions between NG-RAN nodes and the LMF until a suitable configuration of AD to be provided to the UE is obtained.

### Step 3: Assistance Data Transfer

The assistance data may be transferred using the Provide assistance data message from the LMF to the UE or it may be provided via positioning system information broadcast (posSibs).

The network node (e.g. an LMF) in response to the capability report, configures the UE to measure on at least two resources (or two parts of the last resource) transmitted by the TRP that are separated by a certain time interval. The network may indicate the UE the need to receive and process these resources coherently. A possible mechanism is to add to the description of DL-PRS resource a field phaseChoherenceResourcelD which contains the ID of the resource set and resource ID the said resource is phase coherent with. An ASN.1 snippet showing the field phaseCoherenceResourcelD which may be included into the DL-PRS resource configuration is shown as:

### Step 4: Request Location Information

Furthermore, if the phase measurement is to be made between two more OFDM symbols within the DL-PRS resource itself, this information may also be indicated in the assistance data by indicating the pair of symbol index, between which the phase information is to be measured.

### Step 4: Request Location Information

Within the Request Location Information, the LMF may according to embodiments indicate the UE that the phase is requested between two resources provided in the assistance data, where the phaseCoherence is indicated. Note phase coherent refers that the phase deviation from a predefined phase relationship does not exceed a certain margin wherein this margin depends on the relative distance change and/or frequency offset. If, for example, the assistance data indicated the UE to make measurement of phases within different symbols in the resource itself, then it reports the measurements accordingly.

-- ASN1START
NR-Multi-RTT-RequestLocationInformation-r16 ::= SEQUENCE {
nr-UE-RxTxTimeDiffMeasurementInfoRequest-r16

ENUMERATED { true }

OPTIONAL, -- Need ON

| | |
|---|---|
| nr-RequestedMeasurements-r16 | BIT STRING { prsrsrpReq(0), |

phaseRequest(1), phaseDifferenceRequest(2)} (SIZE(1..8)),

| | |
|---|---|
| nr-AssistanceAvailability-r16 | BOOLEAN, |
| nr-Multi-RTT-ReportConfig-r16 | NR-Multi-RTT-ReportConfig-r16, |
| additionalPaths-r16 | ENUMERATED { requested } |

```
  OPTIONAL, -- Need ON
  ...
}
NR-Multi-RTT-ReportConfig-r16 ::= SEQUENCE {
  maxDL-PRS-RxTxTimeDiffMeasPerTRP-r16 INTEGER (1..4)
  OPTIONAL, -- Need ON
  timing ReportingGranularityFactor-r16 INTEGER (0..5)
  OPTIONAL -- Need ON
}
NR-DoublePhase-ReportConfig-r16 ::= SEQUENCE {
```

| | |
|---|---|
| reportingMode | ENUMERATED {wideband(0), subband(1)} |

OPTIONAL, -- Need ON
}
-- ASN1STOP

### Step 5: UE Measurements

If the UE is configured to make measurements on two resources coherently, the UE shall begin the coherent measurement time. During the coherent measurement time, according to one variant, the UE shall maintain the active bandwidth part between the measurements and/or do not switch positioning frequency layers until both resources have been measured. The BWP switching or measurement on a different frequency layer shall be performed once measurement on both of the coherent resources during a measurement occasion have been completed.

According to second variant, the UE shall drop the measurement if it is configured to switch the active BWP, and report an error to the location server.

The UE may be configured to make phase measurements on sub-bands, wherein the bandwidth spanned by the positioning resource may be divided into several sub-bands.

### Step 6: Provide Location Information

During this step, the UE provides the measurement made including phase measurements. The UE may report several subsequent phase measurements after a range measurement. In case of multi-RTT, the UE may report one Tx-Rx time difference, which is the difference in time between the time the UE received the downlink signal to the time when it transmitted the uplink reference signal, followed by one or more phase difference measurements between at least two resources and/or at least two part of a resources separated by a certain time-interval in case of single resource containing multiple OFDM symbols.

According to an embodiment, it may be assumed that the coarse range would stable in short term (and can be monitored with range estimates, such as TDOA or RTT) while the fine range changes more frequently (monitored with phase change).

Therefore, there may be one or more narrowband RS transmissions following the wideband range measurements. Accordingly, the LMF may configure the UE to provide relatively less frequent updates on some resources used for multi-RTT ranging compared to the frequency of updates on narrowband DL-PRS where the phases are being estimated.

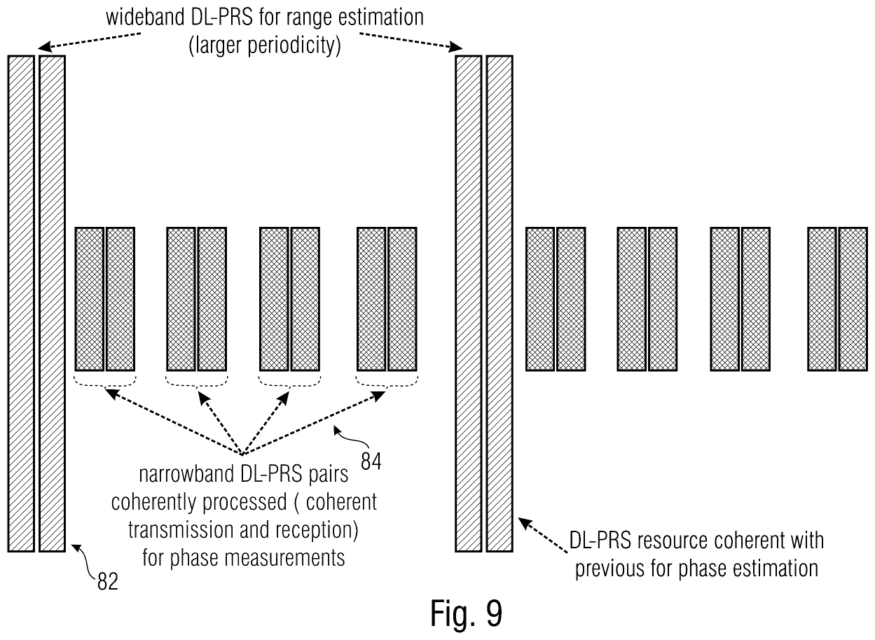

FIG. 9 illustrates the depiction of wideband DL-PRS with low periodicity and narrowband DL-PRS pairs with periodicity. The wideband DL-PRS are marked 84. The usage of the two different DL-PRS has the purpose to allow a lower update rate or coarse range and higher update rate of finer range.

Step 7: NRPPa Positioning Information REQUEST (i.e. Requesting SRS Configuration from NG-RAN Node Hosting the Serving Cell)

Likewise, the LMF may request the UL-PRS (e.g. SRS) configuration from its serving cell indicating it to configure the UE with two resources or a resource covering a sufficient number of OFDM symbols or at least two repetitions of the portion of uplink reference signals which are to be transmitted coherently. The serving cell indicates the coherency requirement to the UE by specifying two resources that are to be transmitted coherently.

The indication from the serving cell also indicates that as long as the resource /resources are being transmitted coherently, the existing priority rules may be overridden by new priority rules favouring the transmission of SRS over transmission of shared channels and/or control channels and/or reference signals.

### Step 8: gNB Determines UL SRS Resources

The gNB takes into account the Positioning information request and determines suitable UL SRS resources. The UL SRS resources may follow the requested configuration from LMF or the gNB may choose its own configuration and/or update the configuration.

### Step 9: Provide UE the SRS Configuration to the UE

The gNB provides the SRS configuration to the UE via RRC reconfiguration. It may optionally also deliver part of SRS configuration via other means—such as position system information delivery or via RRC message delivered through subsequent or small data transmission (SDT) mechanism. The provided configuration may indicate the coherence requirements between two resources, or simply an indication that coherence transmission is expected for this resource. The indication of coherence requirement may change the priority rules concerning the transmission priorities. In one variant, the other transmissions such as PUSCH and/or PRACH and/or PUCCH may be dropped and the SRS transmission may be continued for the duration of the time needed to transmit the resources for measuring phase coherently. In another variant, the UE may drop the resources for phase measurement.

### Step 10: POSITIONING INFORMATION RESPONSE

The gNB provides the SRS configuration it has provided to the UE in Step 9 to the LMF.

### Step 11: Activation of SRS

In case of periodic SRS configuration, this step is not needed since SRS will be activated automatically after receiving the SRS configuration. In case of aperiodic and semi-persistent SRS transmissions, the LMF may trigger the NG-RAN node hosting the serving cell of the UE, which in turn triggers the activation of the said SRS at the UE.

The gNB provides the SRS configuration it has provided to the UE in Step 9 to the LMF.

Step 12: NRPPa Measurement Request (i.e. Making Request to Several TRPs to Measure the Uplink SRS)

The LMF may indicate the one or more of the TRPs to measure resources transmitted by the UE coherently. This may be contained in the NRPPa measurement request. The measurement request contains information on the resources that the TRP is expected to report coherent phase measurements on. The phase of the received SRS signal or any uplink reference signal may be reported as an average of phase over the entire bandwidth spanned by the reference signal and/or reported at a subband granularity level and/or reported at selected subbands. In case of subband selection by the LMF, the LMF may indicate which subbands the TRP needs to report the phase measurements on.

Step 13: UL-PRS (e.g. SRS) Measurements:

According to the Rel. 16 specifications, if the SRS for positioning collides with PUSCH, the SRS is dropped in the symbols where the collision occurs. As a result, the phase continuity between transmitted symbols on either side of a transmission gap may not be maintained. To address this issue, for uplink transmission or for device to device transmission (e.g. sidelink), when the UE is configured or triggered to transmit the positioning resources, the UE begins the uplink coherence transmission window. The coherence transmission window may optionally also be requested by the UE. The NG-RAN node that receives the coherence transmission window request is expected not to schedule other transmission during this period and/or to anticipate that the transmission will be discarded. During the uplink coherence transmission time, according to one variant, the UE is expected to prioritise the transmission of the at least one positioning resource to be transmitted coherently. In line with this variant, the UE may do any one or more of the following to prioritise the transmission of coherent resources for positioning.
1) Avoid switching BWP between transmission of resource/resources.
2) Dropping transmission of PUSCH and/or PUCCH and/or PRACH and/or other reference signals.

According to another variant, the UE may indicate via LPP to the location server or the UE (in sidelink) if the coherence during the configured coherence transmission window is violated. The location server may take this information into account while determining position. One way of doing so would be to discard the phase information measured in such occasion or to interpolate between other occasions where the measurement was valid.

### Step 14: NRPPa Positioning Measurement Response

If a TRP is not able to measure two resources coherently, then it may indicate within the measurement report that the phase difference could not be measured. The TRP may either drop the measurements completely, or it may report the phase measurement on one of the resources, as indicated in measurement and reporting configuration as discussed below.

### Step 15: LMF Processing

The LMF may combine the received phase difference measurement and/or phase measurements made in different resources.

For both uplink and downlink, the UE or TRP may according to embodiments be provided measurement and reporting configuration.

According to further embodiments Measurement and reporting configuration may be as it follows:

The measurement and reporting configuration may be sent to TRP or to an UE, which indicates how the phase and/or phase differences are calculated and reported to a second device (another UE in sidelink. to LMF via another UE in partial coverage scenario (e.g. via relay) and/or to LMF via LPPa interface and/or to the NG-RAN node via RRC interface.)
1. One phase difference per coherent resource pair or one phase difference per repetition pair or phase difference between parts of a resource occupying several OFDM symbols (containing a sequence known to the receiver or a sequence which can be reconstructed by the receiver.)
2. Optional the phase difference may be reported per sub-band
3. Phase difference averaged over N PRS occasions Alternatively, the phase of each occurrence can be reported instead of the difference.

Below, an extension to the sidelink according to further embodiments will be discussed. Sidelink mode with MW support can, for example, be used. According to embodiments

The network may provide assistance data to the UE, wherein after receiving the assistance data the UE transmitting the sidelink positioning reference signal is expected to transmit the second positioning resource coherently with the first positioning resource. Likewise, a second UE and/or a group of second UEs may receive the configuration from the network or via multicast or groupcast from the first UE to determine the resources or resource parts that are transmitted coherently.

The assistance data may be transmitted by the UE in partial coverage to the out-of-coverage UEs by either transmitting the assistance data transparently and/or providing the assistance the UE in partial coverage has received.

In UE-assisted LMF-based mode, the measurement made may be routed through the UE.

In an alternative variant, the phase difference may be converted into position at the UE in partial coverage and this measurement may be indicated to the LMF.

According to further embodiments, autonomous sidelink may not be used. In autonomous sidelink mode, the resource configuration used for sidelink positioning may be indicated to the second UE. In the configuration, the UE may either indicate a following positioning resource that is transmitted whose separation may be fixed (either by configuration received during network coverage or by standards) or it may indicate the time-separation between the resources that are transmitted coherently.

The measurement may be reported to the network via the UE in coverage (e.g. relaying) or may be processed at the LCS client at the UE side (UE-based).

On-demand request from the UE for sidelink positioning signals The UE may request positioning reference signal with certain characteristics from a UE. The characteristics may include: Furthermore, the on-demand request from a UE to another UE may indicate the request for a second resource to be transmitted coherently with a second resource.

Below, further embodiments forming alternative or add-ons will be discussed.

These alternatives/enhancements form further embodiments.

Related to the step (3): D2 may receive the signal and calculated the phase difference d_{φ1}: Periodic or semi-persistent RS: to avoid that the UE or TRP reports a single measurement per multiple received RS occasions. An indication can be sent to the TRP or UE to perform and report measurement results on the multiple measurement occasions. A UE/TRP can be indicated with a measurement window wherein the measurement occasions are occur.

To ensure that the phase difference is not ambiguous: the UE/TRP can be configured with a minimum separation time between the two measurements occasions to be reported.

APeriodic RS: UE/TRP are indicated with the resources to perform measurements on.

According to further embodiments, all of the below-mentioned measurement association options may be used—according to different embodiment—different entity (such as UE in sidelink) are to be associated with a PRS,SRS or a SL-RS resource ID.

According to embodiments,UE/TRP phase measurements reported to the LMF or to a different entity (such as UE in sidelink) are to be associated with a measurement such as RSTD, RTOA, Rx-Tx, AoA, RSRPP or RSRP, wherein multiple reported phase measurements at different time instants within the measurement period can be associated with a single a measurement such as RSTD, RTOA, Rx-Tx, AoA, RSRPP or RSRP.

According to embodiments, UE/TRP phase measurements reported to the LMF or to a different entity (such as UE in sidelink) are to be associated with an:
RxTx Timing error group ID, Rx Timing error group (TEG) ID, Tx Timing error group ID. Wherein the UE is expected to apply the same Rx chain associated for the reported measurements associated with a certain TEG.
RxTx, Rx or Tx timing error margin within a TEG. For phase meaurements the timing error groups association between different resources is only applicable if the RxTx, Rx or Tx timing error margin are calibrated within a measurement over the measurement period: Rx or Tx ARP (antenna radiation pattern)

### Background TEG Definition as Agreed in 3GPP

UE Tx ‘timing error group’ (UE Tx TEG): A UE Tx TEG is associated with the transmissions of one or more UL SRS resources for the positioning purpose, which have the Tx timing errors within a certain margin.

TRP Tx ‘timing error group’ (TRP Tx TEG): A TRP Tx TEG is associated with the transmissions of one or more DL-PRS resources, which have the Tx timing errors within a certain margin.

UE Rx ‘timing error group’ (UE Rx TEG): A UE Rx TEG is associated with one or more DL measurements, which have the Rx timing errors within a certain margin.

TRP Rx ‘timing error group’ (TRP Rx TEG): A TRP Rx TEG is associated with one or more UL measurements, which have the Rx timing errors within a margin.

UE RxTx ‘timing error group’ (UE RxTx TEG): A UE RxTx TEG is associated with one or more UE Rx-Tx time difference measurements, and one or more UL SRS resources for the positioning purpose, which have the ‘Rx timing errors+Tx timing errors' within a certain margin.

TRP RxTx ‘timing error group’ (TRP RxTx TEG): A TRP RxTx TEG is associated with one or more gNB Rx-Tx time difference measurements and one or more DL-PRS resources, which have the ‘Rx timing errors+Tx timing errors' within a certain margin. In general the measurement/phase measurement can be performed on any PRS RS, forming a general positioning reference signal definition which generalized for DL,UL and SL.

Tx timing error: From a signal transmission perspective, there will be a time delay from the time when the digital signal is generated at baseband to the time when the RF signal is transmitted from the Tx antenna. For supporting positioning, the UE/TRP may implement an internal calibration/compensation of the Tx time delay for the transmission of the DL-PRS/UL SRS signals, which may also include the calibration/compensation of the relative time delay between different RF chains in the same TRP/UE. The compensation may also possibly consider the offset of the Tx antenna phase center to the physical antenna center. However, the calibration may not be perfect. The remaining Tx time delay after the calibration, or the uncalibrated Tx time delay is defined as Tx timing error.

Rx timing error: From a signal reception perspective, there will be a time delay from the time when the RF signal arrives at the Rx antenna to the time when the signal is digitized and time-stamped at the baseband. For supporting positioning, the UE/TRP may implement an internal calibration/compensation of the Rx time delay before it reports the measurements that are obtained from the DL-PRS/UL SRS signals, which may also include the calibration/compensation of the relative time delay between different RF chains in the same TRP/UE. The compensation may also possibly consider the offset of the Rx antenna phase center to the physical antenna center. However, the calibration may not be perfect. The remaining Rx time delay after the calibration, or the uncalibrated Rx time delay is defined as Rx timing error. Note, in principled any multi OFDM symbols reference signal in DL, UL or SL is possible to be used as reference signal.

According to embodiments a phase measurement on the first set (e.g. first, second reference signal (14a, 14b)) and/or the second set (third and fourth reference signal) is performed on two reference signals with two different identifiers or different reference signals; alternatively a phase measurement on the first set (e.g. first, second reference signal (14a, 14b)) and/or the second set (third and fourth reference signal) is performed on two reference signals with two different identifiers or different reference signals and wherein a time offset configuration between two reference signals is provided in units or steps of OFDM symbols.

According to embodiments, a phase measurement on the first set (e.g. first, second reference signal (14a, 14b)) and/or the second set (third and fourth reference signal) is performed on two reference signals with two different identifiers or different reference signals. This means that the reference signal of 14a and 14b can be originating from different RS. The technical advantage is that there is no need to define a double burst with a dt time separation so that the double burst is a result of two RS with a defined time offset dt. The time offset configuration between two reference signals can be provided in units/steps of OFDM symbols. According to embodiments, the apparatus performing the measuring is configured to provide in a single report at least two phase measurements or angle measurements associated with a timestamp wherein each measurement is performed at a different time interval; alternatively/additionally the apparatus performing the measuring is configured report multiple phases or angles for different paths or with different antennas or RF chains which can be associated with a group ID such as a TEG ID.

According to embodiments, one or more measured phase or angle is associated with at least one Rx-Tx measurement; wherein the phase difference measurements determines an absolute range using the Rx-Tx measurements, e.g. more accurate than the Rx-Tx measurements on their own; additionally or alternatively one or more measured phase (or angle) is associated with at least one RToA or an RSTD measurement; wherein the phase difference measurements is to determine a UE position information, e.g. more accurate than the RTOA RSTD derived position).

The phase measurement can, according to further embodiments, be used in combination with another localization technique, e.g., being based on initial measurement unit (IMU) or GNSS). Inertial Measurement Unit (IMU) is a device having one or more sensors such as Gyroscopes, Accelerometers and Magnetometers to provide a measure angular rate, acceleration and specific gravity.

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

An embodiment provides an apparatus being a first apparatus and comprising a transceiver and configured to communicate to a second apparatus; wherein the first apparatus is configured to transmit a first reference signal at a first point of time and at least a second reference signal at a second point of time (first and second reference signal also referred to as double burst forward link) to the second apparatus, so that the second apparatus receives the first and the second reference signal in order to calculate a first timing parameter, especially a first phase difference d_{φ1} (d_{φ1}=angle(RS_{22,RX})−angle(RS_{21,RX})) between the first and the second reference signal and/or to report the first timing parameter, especially the first phase difference d_{φ1} or an angle(RS_{22,RX}) and angle(RS_{21,RX})) to another entity, like the LMF, or to the first apparatus; wherein the first apparatus is configured to receive from the second apparatus a third reference signal at a third point of time and at least a fourth reference signal at a fourth point of time (third and fourth reference signal also referred to as to double burst return link); in order to calculate a second timing parameter, especially a second phase difference d_{φ2} (d_{φ2}=angle(RS_{12,RX})−angle(RS_{11,RX})) between the third and the fourth reference signal, and/or to report the second timing parameter, especially the second phase difference d_{φ2} or an angle(RS_{12,RX}) and angle(RS_{11,RX})) to another entity, like the LMF, or to the second apparatus; wherein a distance change and/or a relative speed v of the first and the second apparatus is calculable based on the first timing parameter or the phase difference d_{φ1} and the second timing parameter or the phase difference d_{φ2} or based on the formula d_{φMovement}=(d_{φ1}+d_{φ2})/2.

In accordance with embodiments the apparatus being a first apparatus and comprising a transceiver and configured to communicate to a second apparatus; the first apparatus is configured to transmit a first reference signal at a first point of time and at least a second reference signal at a second point of time (first and second reference signal also referred to as double burst forward link) to the second apparatus; the first apparatus is configured to receive from the second apparatus a third reference signal at a third point of time and at least a fourth reference signal at a fourth point of time (third and fourth reference signal also referred to as to double burst return link); wherein a timing parameter, especially a phase difference d_{φ2} (d_{φ2}=angle(RS_{12,RX})−angle(RS_{11,RX})) between the third and the fourth reference signal is calculable, and/or wherein the first apparatus is configured to report the timing parameter, especially the phase difference d_{φ2} or an angle(RS_{12,RX}) and angle(RS_{11,RX})) to another entity, like the LMF, or to the second apparatus; a distance change and/or a relative speed (v) of the first and the second apparatus is calculable based on the timing parameter or the phase difference d_{φ2} or based on the formula d_{φMovement}=(d_{φ1}+d_{φ2})/2.

In accordance with embodiments, the apparatus being a second apparatus and comprising a transceiver and configured to communicate to a first apparatus; the second apparatus is configured to receive a first and the second reference signal from the first apparatus and to calculate a first timing parameter, especially a first phase difference d_{φ1} (d_{φ1}=angle(RS_{22,RX})−angle(RS_{21,RX})) between the first and the second reference signal and/or to report the first timing parameter, especially the first phase difference d_{φ1} or an angle(RS_{22,RX}) and angle(RS_{21,RX})) to another entity, like the LMF, or to the first apparatus; or wherein the second apparatus is configured to receive a first and a second reference signal and to calculate a first timing parameter, especially a first phase difference d_{φ1} (d_{φ1}=angle(RS_{22,RX})−angle(RS_{21,RX})) between the first and the second reference signal and/or to report the first timing parameter, especially the first phase difference d_{φ1} or an angle(RS_{22,RX}) and angle(RS_{21,RX})) to another entity, like the LMF, or to the first apparatus; the second apparatus is configured to transmit a third reference signal at a first point of time and at least a second reference signal at a fourth point of time (third and fourth reference signal also referred to as to double burst return link); wherein a distance change and/or a relative speed v of the first and the second apparatus is calculable based on the timing parameter or the phase difference d_{φ1} or based on the formula d_{φMovement}=(d_{φ1}+d_{φ2})/2.

In the following, additional embodiments and aspects of the invention will be described which can be used individually or in combination with any of the features and functionalities and details described herein.
1. Apparatus 10, 10a, 10b being a first apparatus and comprising a transceiver and configured to communicate to a second apparatus;
wherein the first apparatus is configured to transmit a first reference signal 14a at a first point of time t₁ and at least a second reference signal 14b at a second point of time t₂ first and second reference 14b signal (also referred to as double burst forward link) to the second apparatus
so that the second apparatus receives the first and the second reference signal 14b in order to calculate a first timing parameter, especially a first phase difference d_{φ1} (d_{φ1}=angle(RS_{22,RX})−angle(RS_{21,RX})) between the first and the second reference signal 14b and/or to report the first timing parameter, especially the first phase difference d_{φ1} or an angle(RS_{22,RX}) and angle(RS_{21,RX})) to another entity, like the LMF 30, or to the first apparatus;
wherein the first apparatus is configured to receive from the second apparatus a third reference signal 16a at a third point of time t₃ and at least a fourth reference signal 16b at a fourth point of time t₄ (third and fourth reference signal 16a, 16b also referred to as to double burst return link);
in order to calculate a second timing parameter, especially a second phase difference d_{φ2} (d_{φ2}=angle(RS_{12,RX})−angle(RS_{11,RX})) between the third and the fourth reference signal 16a, 16b, and/or to report the second timing parameter, especially the second phase difference d_{φ2} or an angle(RS_{12,RX}) and angle(RS_{11,RX})) to another entity, like the LMF 30, or to the second apparatus;
wherein a distance change and/or a relative speed v of the first and the second apparatus is calculable based on the first timing parameter or the phase difference d_{φ1} and the second timing parameter or the phase difference d_{φ2} or based on the formula d_{φMovement}=(d_{φ1}+d_{φ2})/2.
2. Apparatus 10, 10a, 10b being a first apparatus and comprising a transceiver and configured to communicate to a second apparatus;
wherein the first apparatus is configured to transmit a first reference signal 14a at a first point of time t₁ and at least a second reference signal 14b at a second point of time t₂ (first and second reference 14b signal also referred to as double burst forward link) to the second apparatus;
wherein the first apparatus is configured to receive from the second apparatus a third reference signal 16a at a third point of time t₃ and at least a fourth reference signal 16b at a fourth point of time t₄ (third and fourth reference signal 16a, 16b also referred to as to double burst return link);
wherein a timing parameter, especially a phase difference d_{φ2} (d_{φ2}=angle(RS_{12,RX})−angle(RS_{11,RX})) between the third and the fourth reference signal 16a, 16b is calculable, and/or wherein the first apparatus is configured to report the timing parameter, especially the phase difference d_{φ2} or an angle(RS_{12,RX}) and angle(RS_{11,RX})) to another entity, like the LMF 30, or to the second apparatus;
wherein a distance change and/or a relative speed v of the first and the second apparatus is calculable based on the timing parameter or the phase difference d_{φ2} or based on the formula d_{φMovement}=(d_{φ1}+d_{φ2})/2.
3. Apparatus 10, 10a, 10b being a second apparatus and comprising a transceiver and configured to communicate to a first apparatus;
wherein the second apparatus is configured to receive a first and the second reference signal 14b from the first apparatus and to calculate a first timing parameter, especially a first phase difference d_{φ1} (d_{φ1}=angle(RS_{22,RX})−angle(RS_{21,RX})) between the first and the second reference signal 14b and/or to report the first timing parameter, especially the first phase difference d_{φ1} or an angle(RS_{22,RX}) and angle(RS_{21,RX})) to another entity, like the LMF 30, or to the first apparatus; or wherein the second apparatus is configured to receive a first and a second reference signal 14b and to calculate a first timing parameter, especially a first phase difference d_{φ1} (d_{φ1}=angle(RS_{22,RX})−angle(RS_{21,RX})) between the first and the second reference signal 14b and/or to report the first timing parameter, especially the first phase difference d_{φ1} or an angle(RS_{22,RX}) and angle(RS_{21,RX})) to another entity, like the LMF 30, or to the first apparatus;
wherein the second apparatus is configured to transmit a third reference signal 16a at a first point of time t₃ and at least a second reference signal 16b at a fourth point of time t₄ (third and fourth reference signal 16a, 16b also referred to as to double burst return link);
wherein a distance change and/or a relative speed v of the first and the second apparatus is calculable based on the timing parameter or the phase difference d_{φ1} or based on the formula d_{φMovement}=(d_{φ1}+d_{φ2})/2.
4. Apparatus 10, 10a, 10b according to one of the previous aspects, wherein the first and/or second apparatus is configured to be configured by a configuration information; wherein the configuration information comprises information on one or more resources to be used for the first reference signal 14a and the second reference signal 14b (e.g. including a bandwidth portion, a frequency portion and/or slot information) and/or on the first point of time t₁ and second point of time t₂; and/or
wherein the first and/or second apparatus is configured to be configured by another configuration information, wherein the another configuration information comprises information on resources to be used for the third reference signal 16a and the fourth reference signal 16b (e.g., including the bandwidth portion, frequency portion and/or slot information) and/or on the third point of time t₃ and the fourth point of time t₄.
5. Apparatus according to one of the previous aspects, wherein the first apparatus is configured to receive from a third apparatus a fifth reference signal at a fifth point of time and a sixth reference signal at a sixth point of time; in order to calculate a third time parameter, especially a third phase difference between the fifth and sixth reference signal and/or to report the third timing parameter, especially the third phase difference to another entity, like the LMF or to the second apparatus;
wherein a distance change or a relative speed v of the first and second apparatus is calculable. Additionally using the third timing parameter or the third phase difference.
6. Apparatus according to one of the previous aspects, wherein a distance change and/or a relative speed v of the first and the second apparatus is calculable based on a timing parameter describing the time difference between the third point of time t₃ and the second point of time t₂ or between the third point of time t₃ and the first point of time t₁ or between the fourth point of time t₄ and the second point of time t₂.
7. Apparatus according to one of the previous aspects, wherein the LMF and/or base station and/or first apparatus and/or second apparatus is configured to calculate the distance change and/or relative speed v.

According to embodiments a first and second timing parameter, respectively, may be used instead of the first and second phase difference.
8. Apparatus 10, 10a, 10b according to one of the previous aspects, wherein the first apparatus is configured to receive from the second apparatus a third reference signal 16a at a third point of time t₃ and at least a fourth reference signal 16b at a fourth point of time t₄ (third and fourth reference signal 16a, 16b also referred to as to double burst return link); in response to the first and second reference signal 14b.
9. Apparatus 10, 10a, 10b according to one of the previous aspects, wherein the first phase difference d_{φ1} is calculated by the second apparatus based on the angle(RS_{22,RX}) and angle(RS_{21,RX})) or wherein the first phase difference d_{φ1} is calculated by the first apparatus or the another entity based on reported the angle(RS_{22,RX}) and angle(RS_{21,RX})); and/or
wherein the second phase difference d_{φ2} is calculated by the first apparatus based on the angle(RS_{12,RX}) and angle(RS_{11,RX})) or wherein the second phase difference d_{φ2} is calculated by the second apparatus or the another entity based on reported the angle(RS_{12,RX}) and angle(RS_{11,RX}));
wherein the distance or the distance change and/or the relative speed v is calculated by the first and/or second apparatus and/or another the another entity.
10. Apparatus 10, 10a, 10b according to one of the previous aspects, wherein the distance change and/or relative speed v is calculated by the first or the second apparatus or another entity, like the LMF 30, having access to the first and second phase difference d_{φ1} and d_{φ2} or the measured phase.
11. Apparatus 10, 10a, 10b according to one of the previous aspects, wherein a distance change dv is calculated based on the following formula

$$d d = - d {φ}_{M o v ement} / ( 2 * π ) * λ .$$

12. Apparatus 10, 10a, 10b according to one of the previous aspects, wherein the relative speed v is calculated based on the following formula

$$v = dd / {dt}_{1}$$

13. Apparatus 10, 10a, 10b according to one of the previous aspects, wherein a frequency offset df is calculated using the difference of d_{φ1} and d_{φ2} and/or based on the following formula:

$$df = {df}_{1} = - {df}_{2} = ( d {φ}_{1} - d {φ}_{2} ) / ( 4 * π * {dt}_{1} ) .$$

14. Apparatus 10, 10a, 10b according to one of the previous aspects, wherein the calculation of the distance change and/or relative speed v is based on the assumption that a frequency offset between a center frequency of the first apparatus and a second apparatus is df₁=f_{CD1}−f_{CD2}, wherein the expected phase difference is d_{φ1}=2*π*df₁*dt₁+d_{φMovement}, where d_{φMovement} represents the phase change resulting from the distance change.
15. Apparatus 10, 10a, 10b according to one of the previous aspects, wherein the phase change results from a frequency offset and a relative distance change; and/or
wherein a phase change between two measurements resulting from frequency offset is eliminated.
16. Apparatus 10, 10a, 10b according to one of the previous aspects, wherein a phase measurement of the first, second, third, and/or forth reference signal comprises cyclic correlation; and/or
wherein a phase measurement of the first, second, third, and/or forth reference signal is performed in frequency domain, or wherein a phase of the first, second, third, and/or forth reference signal is derived from a complex valued correlation function in a time/delay domain.
17. Apparatus 10, 10a, 10b according to one of the previous aspects, wherein a phase measurement on a first set (e.g. first, second reference signal 14a, 14b) and/or on a second set (third and fourth reference signal 16a, 16b) is performed on a PRS signal, where a measured phase difference is derived from phase measurements on different parts of the PRS signal; and/or
where the PRS uses several OFDM symbols and different OFDM symbols which are selected for the phase measurements;
wherein a phase measurement on a first set (e.g. first, second reference signal 14a, 14b) and/or on a second set (third and fourth reference signal 16a, 16b) is performed on the PRS which can be a DL-PRS signal, UL-PRS or SL-PRS or any multi OFDM symbols reference signal in DL, UL or SL.
18. Apparatus 10, 10a, 10b according to of the previous aspects, wherein a phase measurement on the first set (e.g. first, second reference signal 14a, 14b) and/or on the second set (third and forth reference signal) is performed on a PRS signal, where a measured phase difference is derived from phase measurements on different parts of a PRS signal; and/or

wherein the PRS uses several OFDM symbols (with or without staggering); and/or
wherein a phase measurement on the first set (e.g. first, second reference signal 14a, 14b) and/or on the second set (third and forth reference signal) performed on the PRS which can be a DL-PRS signal, UL-PRS or SL-PRS or any multi OFDM symbols reference signal in DL, UL or SL.
19. Apparatus 10, 10a, 10b according to one of the previous aspects, wherein a phase measurement on the first set (e.g. first, second reference signal 14a, 14b) and/or the second set (third and fourth reference signal) is performed on a DM-RS signal or a CSI-RS signal or other double burst signal or other signal containing at least two symbols.
20. Apparatus 10, 10a, 10b according to of the previous aspects, wherein a phase measurement on the first set (e.g. first, second reference signal 14a, 14b) and/or the second set (third and fourth reference signal) is performed on two reference signals with two different identifiers or different reference signals; or
wherein a phase measurement on the first set (e.g. first, second reference signal 14a, 14b) and/or the second set (third and fourth reference signal) is performed on two reference signals with two different identifiers or different reference signals and wherein a time offset configuration between two reference signals is provided in units or steps of OFDM symbols.
21. Apparatus 10, 10a, 10b according to of the previous aspects, wherein a phase measurement on the first set (e.g. first, second reference signal 14a, 14b) and/or the second set (third and fourth reference signal 16a, 16b) is composed of two or more OFDM symbols containing a sequence known to the receiver or a sequence which can be reconstructed by the receiver.
22. Apparatus 10, 10a, 10b according to of the previous aspects, wherein the first apparatus or a LMF 30 is informed which two resources belonging to a resource set are transmitted coherently by the TRP and/or a second UE; and/or
wherein the first apparatus is requested for phase measurement by a message from the LMF 30, gNB 20 or another entity; and/or
wherein the first apparatus assumes the reference signals on which the measurements are to performed on being coherent, if a phase measurement is requested on two measurement instants within the same or different resources.
23. Apparatus 10, 10a, 10b according to of the previous aspects, wherein the first apparatus or a LMF30 communicating with the first apparatus receives information indicating phaseCoherency between two resources is expected to receive these resources in a phase coherent manner, e.g. frequency offset not adjusted between two transmissions;
wherein the first apparatus or a LMF30 communicating with the first apparatus receives information indicating a time offset configuration between two reference signals, especially provided in units/steps of OFDM symbols.
24. Apparatus 10, 10a, 10b according to one of the previous aspects, wherein at least one apparatus is further configured to take into account information being based on another localization technique, IMU measurements or a GNSS signal.
25. Apparatus 10, 10a, 10b according to of the previous aspects, wherein the first apparatus or a LMF 30 communicating with the first apparatus is configured to request on-demand PRS where a PRS is transmitted phase coherent with the existing PRS, or where two resources are requested to be phase coherent with one another or where explicit parameters defining the DL-PRS resource are requested.
26. Apparatus 10, 10a, 10b according to one of the previous aspects, wherein a configuration of wide bandwidth DL-PRS with lower periodicity and narrowband DL-PRS pairs with higher periodicity is used to allow lower update rate of coarse range and higher update rate of finer range.
27. Apparatus 10, 10a, 10b according to one of the previous aspects, wherein the first and/or second apparatus and/or the transmission of the first, second, third and fourth reference signal 16a, 16b is configured based on an RS configuration information provided by the network or another apparatus.
28. Apparatus 10, 10a, 10b according to one of the previous aspects, wherein the apparatus performing the measuring is configured to provide in a single report at least two phase measurements or angle measurements associated with a timestamp wherein each measurement is performed at a different time interval; and/or
wherein the apparatus performing the measuring is configured report multiple phases or angles for different paths or with different antennas or RF chains which can be associated with a group ID such as a TEG ID.
29. Apparatus 10, 10a, 10b according to one of the previous aspects, wherein one or more measured phase or angle is associated with at least one Rx-Tx measurement; wherein the phase difference measurements determines an absolute range using the Rx-Tx measurements; and/or
wherein one or more measured phase or angle is associated with at least one RToA or an RSTD measurement; wherein the phase difference measurements is to determine a UE position information.
30. Apparatus 10, 10a, 10b according to one of the previous aspects, wherein the first and/or second apparatus is configured to receive an RS configuration; and/or
wherein the RS configuration comprises at least one of the following settings:
   Measurement update rate (measurement period)
   Number of RS-RR transmissions related to one measurement (2 or more RS signal transmission per direction). For one set of measurements a “RS-RR set” can be defined
   “RS-RR set” is defined by
      Time difference between the RSs belonging to one set (dt₁ and dt₂).
      Bandwidth of the RSs (complete carrier bandwidth or part of it)
      Other parameter of the RSs (sequence ID, COMB-factor, COMB offset, cyclic shift, . . . )
      Number of OFDM symbols per RS (one or more)
      Maximum time difference between the start of the RS for forward link and return link (difference between t₃ and t₁)
   dt₁ and dt₂ is selected according the frequency offset range and the speed range
   The difference between t₃ and t₁ is not critical and is selected according to the frequency stability
      The return link may transmit after receiving the forward link signal: t₃ >t₁ and t₃ >t₂
      Interlaced: t₃ >t₁ and t₃<t₂
      The return link may transmit before the forward link: t₃<t₁
   Several UEs may respond to one UE, e.g.
      One UE or TRP transmits a RS-RR
      The RS-RR is received by several devices
      Several devices (e.g. roadside units (RSU) or other UEs) may respond
   If several devices respond to a first device, the devices may use orthogonal sequences (different COMB offset, different cyclic shifts) or sequences selected according cross correlation properties (different sequence ID, for example)
Periodic or semi-persistent measurements may be configured (e.g. defined by the measurement update rate) or a single set of measurement (aperiodic) is configured
   A aperiodic measurement set may include several RS-RR sets to increase the accuracy by averaging, for example.
31. Apparatus 10, 10a, 10b according to aspect 29 or 30, wherein the RS configuration is determined by the network (if UE is in coverage) or another UE (if the sidelink is used for the measurements) and/or wherein the RS configuration is transmitted by the network, the base station, the gNB 20 based on request of the first and/or second apparatus.
32. Apparatus 10, 10a, 10b according to one of the previous aspects, wherein a first and second reference signal 14a, 14b and/or the third and fourth reference signal form a double burst signal;
wherein the first, second, third, fourth reference signals 14a, 14b, 16a, 16b are out of the group comprising:
   DL-PRS
   SRS
   CSI-RS
   DM-RS.
33. Apparatus 10, 10a, 10b according to one of the previous aspects, wherein the second apparatus is configured to perform the measurement on the first set of symbols and to report on the measured phase d_{φ1} or the angle(RS_{22,RX}) and angle(RS_{21,RX})) or more symbols belonging to the same set; and/or wherein the first apparatus is configured to perform the measurement on the second set of symbols and to report on the measured second phase d_{φ2} or angle(RS_{12,RX}) and angle(RS_{11,RX})) or more symbols belonging to the same set.
34. Apparatus 10, 10a, 10b according to one of the previous aspects, wherein angle (RS_{22,RX}) is defined as being dependent or equal to the phase; and/or
wherein the phase is defined by a measured angle/phase in the frequency domain at one or more sub-carrier or in time domain from a received path of the channel response from the RS signal, wherein the path corresponds to a given path which can be the first detected path by the UE; and/or
wherein the phase is derived from a IQ report of a single or multiple paths.
35. Apparatus 10, 10a, 10b according to one of the previous aspects, wherein the phase measurements are translated to frequency measurements; and/or where the phase/angle is represented as a change in frequency given by

$${df}_{x} = ( 1 / ( 2 * pi ) ) * ( d {φ}_{x} / {dt}_{x} ) .$$

36. Apparatus 10, 10a, 10b according to one of the previous aspects, wherein the measurement is performed based on one of the following principles:
   Measurement of the phase of a single sub-carrier
   Averaging over the phase of several sub-carrier
   Calculate the correlation of the transmit and receive signal and report the phase of the correlation “lobe” related to the first arriving path.
37. Apparatus 10, 10a, 10b according to aspect 36, wherein the report comprises at least one of the following measurements:
   Phase of the received signal
   Difference of the phase (example: D1 calculates the range. D2 reports the measurement of the phase on the signal received from D1 and reports back the phase difference (d_{φ1} in the example)
   Other data (The reports and related measurements are not in the scope of this invention, but the new reports may be added to existing reports), like RTT measurements, signal quality information or beam information.
38. Apparatus 10, 10a, 10b according to one of the previous aspects, wherein the phase difference calculation and/or the distance calculation and/or a relative speed v calculation is performed by the first apparatus, second apparatus and/or a LMF 30.
39. Another apparatus (being the second (or the first) apparatus comprising a transceiver and configured to communicate to a first apparatus which transmits a first reference signal 14a at a first point of time t₁ and at least a second reference signal 14b at a second point of time t₂ (first and second reference signal 14a, 14b also referred to as double burst forward link) to the second apparatus;
wherein the second apparatus is configured to receive the first and the second reference signal 14a, 14b in order to calculate a first timing parameter, especially a first phase difference d_{φ1} (d_{φ1}=angle(RS_{22,RX})−angle(RS_{21,RX})) between the first and the second reference signal 14a, 14b and/or to report the first timing parameter, especially the first phase difference d_{φ1} or an angle(RS_{22,RX}) and angle(RS_{21,RX})) to another entity, like the LMF 30, to the first apparatus;
wherein the second apparatus is configured to transmit a third reference signal 16a at a third point of time t₃ and at least a fourth reference signal 16b at a fourth point of time t₄ (third and fourth reference signal 16a, 16b also referred to as to double burst return link) in response to the first and second reference signal 14a, 14b to the first apparatus in order to calculate a second timing parameter, especially a second phase difference d_{φ2} (d_{φ2}=angle(RS_{12,RX})−angle(RS_{11,RX})) between the third and the fourth reference signal 16a, 16b, and/or to report the second timing parameter, especially the second phase difference d_{φ2} or an angle(RS_{12,RX}) and angle(RS_{11,RX})) to another entity, like the LMF 30, or to the second apparatus;
wherein a distance change and/or a relative speed v of the first and the second apparatus is calculable based on the first timing parameter or the phase difference d_{φ1} and the second timing parameter or the phase difference d_{φ2} or based on the formula d_{φMovement}=(d_{φ1}+d_{φ2})/2.
40. Apparatus 10, 10a, 10b according to one of the previous aspects, wherein the apparatus 10, 10a, 10b comprises one of the following: a user equipment, mobile device, smartphone, smart device, IoT device, vehicle, road side unit, non-terrestrial component, drone, satellite, gNB 20, NG RAN node, IAB node, TRP, LMF 30.
41. Positioning system comprising at least the first apparatus according to one of aspects 1, 2, 4-38 and the second apparatus according to aspect 3, 4-38 or 39-40.
42. Positioning system according to aspect 41, further comprising a LMF 30.
43. Positioning system according to aspect 42, wherein the LMF 30 is configured to receive a report from the apparatus 10, 10a, 10b or the other apparatus and/or to initiate a measurement performed by the first and/or the second apparatus or to calculate a distance change and/or a relative speed v of the first and the second apparatus.
44. Positioning system according to aspect 41, 42 or 43, wherein the LMF and/or a base station provides a configuration information to the first and/or second apparatus,
wherein the configuration information comprises information on one or more resources to be used for the first reference signal 14a and the second reference signal 14b (e.g. including a bandwidth portion, a frequency portion and/or slot information) and/or on the first point of time t₁ and second point of time t₂ and/or information on resources to be used for the third reference signal 16a and the fourth reference signal 16b (e.g., including the bandwidth portion, frequency portion and/or slot information) and/or on the third point of time t₃ and the fourth point of time t₄.
45. Method for performing position determination performed by a first apparatus, comprising the steps:
transmitting a first reference signal 14a at a first point of time t₁ and at least a second reference signal 14b at a second point of time t₂ (first and second reference signal 14a, 14b also referred to as double burst forward link) to a second apparatus
so that the second apparatus receives the first and the second reference signal 14a, 14b in order to calculate a first phase difference d_{φ1} (d_{φ1}=angle(RS_{22,RX})−angle(RS_{21,RX})) between the first and the second reference signal 14a, 14b and/or to report the first phase difference d_{φ1} or the angle(RS_{22,RX}) and angle(RS_{21,RX})) to another entity, like the LMF 30, to the first apparatus;
receiving from the second apparatus a third reference signal 16a at a third point of time t₃ and at least a fourth reference signal 16b at a fourth point of time t₄ (third and fourth reference signal 16a, 16b also referred to as to double burst return link) in response to the first and second reference signal 14a, 14b in order to calculate a second phase difference d_{φ2} (d_{φ2}=angle(RS_{12,RX})−angle(RS_{11,RX})) between the third and the fourth reference signal 16a, 16b, and/or to report second phase difference d_{φ2} the angle(RS_{12,RX}) and angle(RS_{11,RX})) to another entity, like the LMF 30, or to the second apparatus;
wherein a distance or distance change and/or a relative speed v of the first and the second apparatus is calculable based on d_{φ1} and d_{φ2} or based on the formula d_{φMovement}=(d_{φ1}+d_{φ2})/2.
46. Method for performing position determination performed by a second apparatus, comprising the steps:
receiving a first and at least a second reference signal 14b transmitted by the first apparatus, the first reference signal 14a is transmitted at a first point of time t₁ and the second reference signal 14b is transmitted at a second point of time t₂ (first and second reference signal 14a, 14b also referred to as double burst forward link in order to calculate a first phase difference d_{φ1} (d_{φ1}=angle(RS_{22,RX})−angle(RS_{21,RX})) between the first and the second reference signal 14a, 14b and/or to report the first phase difference d_{φ1} or the angle(RS_{22,RX}) and angle(RS_{21,RX})) to another entity, like the LMF 30, to the first apparatus;
transmitting a third reference signal 16a at a third point of time t₃ and at least a fourth reference signal 16b at a fourth point of time t₄ (third and fourth reference signal 16a, 16b also referred to as to double burst return link) in response to the first and second reference signal 14a, 14b to the first apparatus
in order to calculate a second phase difference d_{φ2} (d_{φ2}=angle(RS_{12,RX})−angle(RS_{11,RX})) between the third and the fourth reference signal 16a, 16b, and/or to report second phase difference d_{φ2} the angle(RS_{12,RX}) and angle(RS_{11,RX})) to another entity, like the LMF 30, or to the second apparatus;
wherein a distance or distance change and/or a relative speed v of the first and the second apparatus is calculable based on d_{φ1} and d_{φ2} or based on the formula d_{φMovement}=(d_{φ1}+d_{φ2})/2.
47. Method according to 44 or 45, further comprising one or more of the following steps:
   Exchange DL-PRS configuration information on NRPPa;
   Exchange information on performing capability;
   Performing on-demand PRS procedure;
   Transferring assistance data;
   Requesting location information;
   Performing UE measurements;
   Providing location information;
   Requesting NRPP a positioning information (i.e. Requesting SRS
   configuration from NG-RAN node hosting the serving cell);
   gNB determines UL SRS resources;
   Providing the SRS configuration to the UE;
   Positioning information response;
   Activation of SRS;
   Requesting NRPPa measurement (i.e. making request to several
   TRPs to measure the uplink SRS);
   Measuring UL-PRS (e.g. SRS);
   Responding by reporting positioning measurement over NRPPa;
   Performing LMF processing.
48. Computer program for performing the method according to aspect 46, 46 or 47.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

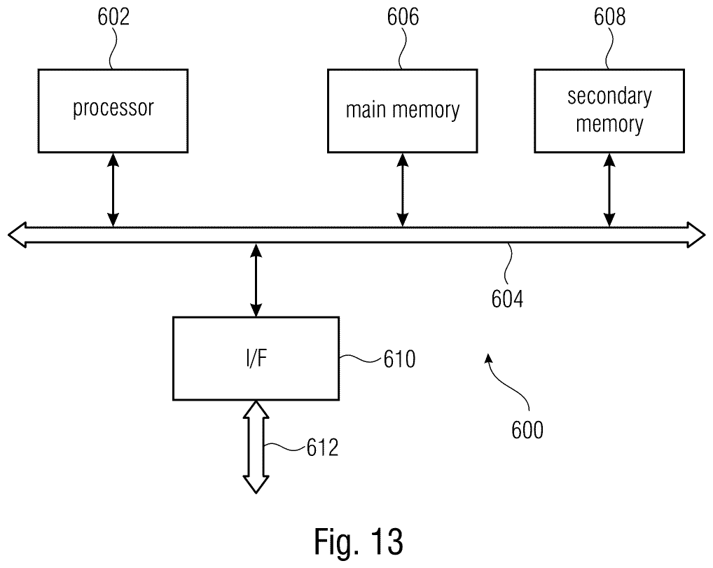

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### ABBREVIATIONS

AMF Access and mobility function
BS Base station
CA carrier aggregation
CSI-RS CSI=channel state information
CSI-RS reference signal used to aquire the CSI
DL Downlink
DL-PRS Downlink positioning reference signal
DMRS or DM RS demodulation reference signals
FL Frequency layer
gNB Next generation node B
GNSS Global navigation satellite system
LMF User Equipment
LPP LTE positioning protocol
NR New radio
NRPPa New radio positioning protocol annex
OOC Out-Of-Coverage
OFDM Orthogonal frequency division multiplex
PSFCH Physical Sidelink Feedback Channel
P-UE Pedestrian UE: should not be limited to pedestrians, but
represents any UE with a need to save power, e.g. electrical
cars, cyclists,
PRS Positioning reference signals
RAN radio access network
RS Reference signal
RS-RR Reference signal for relative ranging. May be an existing RS or
a RS defined in future versions of the 3GPP standard for
ranging (distance measurement between devices) purpose
RTT Round trip time
RE resource elements
SINR Signal to interference and noise ratio
SRS Sounding reference signal,
SRS is also used for positioning purpose
SL Sidelink
SPRS, SP-PRS Sidelink positioning reference signals
ToA Time of arrival
TDOA Time difference of arrival
V2X Vehicle to anything
BWP Bandwidth Part
FL Frequency layer
TEG Timing Error Group
TRP transmit and reception points
ZC (sequence) Zadoff-Chu sequence
UE User equipment
UL Uplink

### REFERENCES

[RedFIR] von der Gruen, Thomas and Franke, Norbert and Wolf, Daniel and Witt, Nicolas and Eidloth, Andreas, A Real-Time Tracking System for Football Match and Training Analysis,” Springer, Berlin, Heidelberg, 2011-12.
[R1-19011861 Fraunhofer IIS, Fraunhofer HHI: Carrier Phase enhanced potential solution for NR positioning schemes, 3GPP TSG RAN WG1 Ad-Hoc Meeting 1901, Taipei, Taiwan, January 21th-25th, 2019
TS 38.211 3GPP, NR; Physical channels and modulation, Rel. 16, v 16.7.0, 2021.09.28
TS 38.305 3G Radio Access Network (NG-RAN); Stage 2 functional specification of

1. Apparatus being a first apparatus and belonging to a positioning system comprising the first apparatus and a second apparatus, the first apparatus comprising a transceiver and configured to communicate to the second apparatus;
wherein the first apparatus is configured to transmit a first reference signal at a first point of time and at least a second reference signal at a second d point of time (first and second reference signal also referred to as double burst forward link) to the second apparatus so that the second apparatus receives the first and the second reference signal in order to calculate a first phase difference d_{φ1} (d_{φ1}=angle(RS_{22,RX})
angle(RS_{21,RX})) between the first and the second reference signal and to report the first phase difference d_{φ1} or an angle(RS_{22,RX}) and angle(RS_{21,RX})) to another entity of the positioning system, like the LMF, or to the first apparatus;
wherein the first apparatus is configured to receive from the second apparatus a third reference signal at a third point of time and at least a fourth reference signal at a fourth point of time (third and fourth reference signal (16a, 16b) also referred to as to double burst return link);
and to calculate a second phase difference d_{φ2} (d_{φ2}=angle(RS_{12,RX})−angle(RS_{11,RX})) between the third and the fourth reference signal (16a, 16b), and to report the second phase difference d_{φ2} or an angle(RS_{12,RX}) and angle(RS_{11,RX})) to another entity, like the LMF, or to the second apparatus;
wherein the first apparatus or the another entity is configured to calculate a distance change or a relative speed (v) of the first and the second apparatus based on the first phase difference d_{φ1} and the second phase difference d_{φ2} or based on the formula d_{φMovement}=(d_{φ1}+d_{φ2})/2.

2. Apparatus being a first apparatus and belonging to a positioning system comprising the first apparatus and a second apparatus, the first apparatus comprising a transceiver and configured to communicate to the second apparatus;
wherein the first apparatus is configured to transmit a first reference signal at a first point of time and at least a second reference signal at a second point of time (first and second reference signal also referred to as double burst forward link) to the second apparatus; wherein a first phase difference d_{φ1} (d_{φ1}=angle(RS_{22,RX})−angle(RS_{21,RX})) between the first and the second reference signal is calculable;
wherein the first apparatus is configured to receive from the second apparatus a third reference signal at a third point of time and at least a fourth reference signal at a fourth point of time (third and fourth reference signal also referred to as to double burst return link);
wherein a second phase difference d_{φ2} (d_{φ2}=angle(RS_{12,RX})−angle(RS_{11,RX})) between the third and the fourth reference signal is calculable, and wherein the first apparatus is configured to report the phase difference d_{φ2} or an angle(RS_{12,RX}) and angle(RS_{11,RX})) to another entity of the positioning system, like the LMF, or to the second apparatus;
wherein the first apparatus or the another entity is configured to calculate a distance change or a relative speed (v) of the first and the second apparatus based the first phase difference d_{φ1} and on the phase difference d_{φ2} or based on the formula d_{φMovement}=(d_{φ1}+d_{φ2})/2.

3. Apparatus being a second apparatus and belonging to a positioning system comprising the first apparatus and a second apparatus, the second apparatus comprising a transceiver and configured to communicate to the first apparatus;
wherein the second apparatus is configured to receive a first and the second reference signal from the first apparatus and to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity, like the LMF, or to the first apparatus; or wherein the second apparatus is configured to receive a first and a second reference signal and to calculate a first phase difference d_{φ1} (d_{φ1}=angle(RS_{22,RX})−angle(RS_{21,RX})) between the first and the second reference signal and to report the first phase difference d_{φ1} or an angle(RS_{22,RX}) and angle(RS_{21,RX})) to another entity of the positioning system, like the LMF, or to the first apparatus;
wherein the second apparatus is configured to transmit a third reference signal at a first point of time and at least a second reference signal at a fourth point of time (third and fourth reference signal also referred to as to double burst return link) so that a second phase difference d_{φ2} (d_{φ2}=angle(RS_{12,RX})
angle(RS_{11,RX})) between the third and the fourth reference signal is calculable;
wherein the second apparatus or the another entity is configured to calculate a distance change or a relative speed of the first and the second apparatus based the first phase difference d_{φ1} and on the phase difference d_{φ1} or based on the formula d_{φMovement}=(d_{φ1}+d_{φ2})/2.

4. Apparatus according to claim 1, wherein the first and/or second apparatus is configured to be configured by a configuration information; wherein the configuration information comprises information on one or more resources to be used for the first reference signal and the second reference signal (e.g. comprising a bandwidth portion, a frequency portion and/or slot information) and/or on the first point of time and second point of time; and/or
wherein the first and/or second apparatus is configured to be configured by another configuration information, wherein the another configuration information comprises information on resources to be used for the third reference signal and the fourth reference signal (e.g., comprising the bandwidth portion, frequency portion and/or slot information) and/or on the third point of time and the fourth point of time.

5. Apparatus according to claim 1, wherein the first apparatus is configured to receive from a third apparatus a fifth reference signal at a fifth point of time and a sixth reference signal at a sixth point of time; in order to calculate a third phase difference between the fifth and sixth reference signal and/or to report the third phase difference to another entity, like the LMF or to the second apparatus;
wherein a distance change or a relative speed of the first and second apparatus is calculable, Additionally using the third phase difference.

6. Apparatus according to claim 1, wherein a distance change and/or a relative speed of the first and the second apparatus is calculable based on a timing parameter describing the time difference between the third point of time and the second point of time or between the third point of time and the first point of time or between the fourth point of time and the second point of time.

7. Apparatus according to claim 1, wherein the LMF and/or base station and/or first apparatus and/or second apparatus is configured to calculate the distance change and/or relative speed.

8. Apparatus according to claim 1, wherein the first apparatus is configured to receive the third reference signal and the at least a fourth reference signal, the third reference signal and the at least a fourth reference signal, in response to the first and second reference signal.

9. Apparatus according to claim 1, wherein the first phase difference d_{φ1} is calculated by the second apparatus based on the angle(RS_{22,RX}) and angle(RS_{21,RX})) or wherein the first phase difference d_{φ1} is calculated by the first apparatus or the another entity based on reported the angle(RS_{22,RX}) and angle(RS_{21,RX})); and/or
wherein the second phase difference d_{φ2} is calculated by the first apparatus based on the angle(RS_{12,RX}) and angle(RS_{11,RX})) or wherein the second phase difference d_{φ2} is calculated by the second apparatus or the another entity based on reported the angle(RS_{12,RX}) and angle(RS_{11,RX})); and
wherein the distance or the distance change or the relative speed is calculated by the first and/or second apparatus and/or another the another entity.

10. Apparatus according to claim 1, wherein the distance change and/or relative speed is calculated by the first or the second apparatus or another entity, like the LMF, having access to the first and second phase difference d_{φ1} and d_{φ2} or the measured phase.

11. Apparatus according to claim 1, wherein a distance change dv is calculated based on the following formula
$$dd = - d {φ}_{M o v ement} / ( 2 * π ) * λ .$$

12. Apparatus according to claim 1, wherein the relative speed is calculated based on the following formula
$$v = dd / {dt}_{1}$$

13. Apparatus according to claim 1, wherein a frequency offset df is calculated using the difference of d_{φ1} and d_{φ2} and/or based on the following formula:
$$df = {df}_{1} = - {df}_{2} = ( d {φ}_{1} - d {φ}_{2} ) / ( 4 * π * {dt}_{1} ) .$$

14. Apparatus according to claim 1, wherein the calculation of the distance change and/or relative speed is based on the assumption that a frequency offset between a center frequency of the first apparatus and a second apparatus is df₁=f_{CD1}−f_{CD2},
wherein the expected phase difference is d_{φ1}=2*π*df₁*dt₁+d_{φMovement}, where d_{φMovement} represents the phase change resulting from the distance change.

15. Apparatus according to claim 1, wherein the phase change results from a frequency offset and a relative distance change; and/or
wherein a phase change between two measurements resulting from frequency offset is eliminated.

16. Apparatus according to claim 1, wherein a phase measurement of the first, second, third, and/or forth reference signal comprises cyclic correlation; and/or
wherein a phase measurement of the first, second, third, and/or forth reference signal is performed in frequency domain, or wherein a phase of the first, second, third, and/or forth reference signal is derived from a complex valued correlation function in a time/delay domain.

17. Apparatus according to claim 1, wherein a phase measurement on a first set (e.g. first, second reference signal) and/or on a second set (third and fourth reference signal) is performed on a PRS signal, where a measured phase difference is derived from phase measurements on different parts of the PRS signal; and/or
where the PRS uses several OFDM symbols and different OFDM symbols which are selected for the phase measurements;
wherein a phase measurement on a first set (e.g. first, second reference signal) and/or on a second set (third and fourth reference signal) is performed on the PRS which can be a DL-PRS signal, UL-PRS or SL-PRS or any multi OFDM symbols reference signal in DL, UL or SL.

18. Apparatus according to claim 1, wherein a phase measurement on the first set (e.g. first, second reference signal) and/or on the second set (third and forth reference signal) is performed on a PRS signal, where a measured phase difference is derived from phase measurements on different parts of a PRS signal; and/or
wherein the PRS uses several OFDM symbols (with or without staggering); and/or
wherein a phase measurement on the first set (e.g. first, second reference signal) and/or on the second set (third and forth reference signal) performed on the PRS which can be a DL-PRS signal, UL-PRS or SL-PRS or any multi OFDM symbols reference signal in DL, UL or SL.

19. Apparatus according to claim 1, wherein a phase measurement on the first set (e.g. first, second reference signal) and/or the second set (third and fourth reference signal) is performed on a DM-RS signal or a CSI-RS signal or other double burst signal or other signal comprising at least two symbols.

20. Apparatus according to claim 1, wherein a phase measurement on the first set (e.g. first, second reference signal) and/or the second set (third and fourth reference signal) is performed on two reference signals with two different identifiers or different reference signals; or
wherein a phase measurement on the first set (e.g. first, second reference signal) and/or the second set (third and fourth reference signal) is performed on two reference signals with two different identifiers or different reference signals and wherein a time offset configuration between two reference signals is provided in units or steps of OFDM symbols.

21. Apparatus according to claim 1, wherein a phase measurement on the first set (e.g. first, second reference signal) and/or the second set (third and fourth reference signal) is composed of two or more OFDM symbols comprising a sequence known to the receiver or a sequence which can be reconstructed by the receiver.

22. Apparatus according to claim 1, wherein the first apparatus or a LMF provides an information on two resources belonging to a resource set and being transmitted coherently by the TRP and/or a second UE; and/or
wherein the first apparatus is requested for phase measurement by a message from the LMF, gNB or another entity; and/or
wherein the first apparatus assumes the reference signals on which the measurements are to performed on being coherent, if a phase measurement is requested on two measurement instants within the same or different resources.

23. Apparatus according to claim 1, wherein the first apparatus or a LMF communicating with the first apparatus receives information indicating phaseCoherency between two resources is expected to receive these resources in a phase coherent manner, e.g. frequency offset not adjusted between two transmissions;
wherein the first apparatus or a LMF communicating with the first apparatus receives information indicating a time offset configuration between two reference signals, especially provided in units/steps of OFDM symbols.

24. Apparatus according to one of the previous claims, wherein at least one apparatus is further configured to take into account information being based on another localization technique, IMU measurements or a GNSS signal.

25. Apparatus according to claim 1, wherein the first apparatus or a LMF communicating with the first apparatus is configured to request on-demand PRS where a PRS is transmitted phase coherent with the existing PRS, or where two resources are requested to be phase coherent with one another or where explicit parameters defining the DL-PRS resource are requested.

26. Apparatus according to claim 1, wherein a configuration of wide bandwidth DL-PRS with lower periodicity and narrowband DL-PRS pairs with higher periodicity is used to allow lower update rate of coarse range and higher update rate of finer range.

27. Apparatus according to claim 1, wherein the first and/or second apparatus and/or the transmission of the first, second, third and fourth reference signal is configured based on an RS configuration information provided by the network or another apparatus.

28. Apparatus according to claim 1, wherein the apparatus performing the measuring is configured to provide in a single report at least two phase measurements or angle measurements associated with a timestamp wherein each measurement is performed at a different time interval; and/or
wherein the apparatus performing the measuring is configured report multiple phases or angles for different paths or with different antennas or RF chains which can be associated with a group ID such as a TEG ID.

29. Apparatus according to claim 1, wherein one or more measured phase or angle is associated with at least one Rx-Tx measurement; wherein the phase difference measurements determines an absolute range using the Rx-Tx measurements; and/or
wherein one or more measured phase (or angle) is associated with at least one RToA or an RSTD measurement; wherein the phase difference measurements is to determine a UE position information.

30. Apparatus according to claim 1, wherein the first and/or second apparatus is configured to receive an RS configuration; and/or
wherein the RS configuration comprises at least one of the following settings:
Measurement update rate (measurement period)
Number of RS-RR transmissions related to one measurement (2 or more RS signal transmission per direction). For one set of measurements a “RS-RR set” can be defined
“RS-RR set” defined by
Time difference between the RSs belonging to one set (dt₁ and dt₂)
Bandwidth of the RSs (complete carrier bandwidth or part of it)
Other parameter of the RSs (sequence ID, COMB-factor, COMB offset, cyclic shift, . . . )
Number of OFDM symbols per RS (one or more)
Maximum time difference between the start of the RS for forward link and return link (difference between t₃ and t₁)
dt₁ and dt₂ is selected according the frequency offset range and the speed range
difference between t₃ and t₁ is not critical and is selected according to the frequency stability
The return link may transmit after receiving the forward link signal: t₃ >t₁ and t₃ >t₂
Interlaced: t₃ >t₁ and t₃<t₂
The return link may transmit before the forward link: t₃<t₁
Several UEs may respond to one UE, e.g.
One UE or TRP transmits a RS-RR
The RS-RR is received by several devices
Several devices (e.g. roadside units (RSU) or other UEs) may respond
If several devices respond to a first device, the devices may use orthogonal sequences (different COMB offset, different cyclic shifts) or sequences selected according cross correlation properties (different sequence ID, for example)
Periodic or semi-persistent measurements may be configured (e.g. defined by the measurement update rate) or a single set of measurement (aperiodic) is configured
A aperiodic measurement set may comprise several RS-RR sets to increase the accuracy by averaging, for example.

31. Apparatus according to claim 30, wherein the RS configuration is determined by the network (if UE is in coverage) or another apparatus (if the sidelink is used for the measurements) and/or wherein the RS configuration is transmitted by the network, the base station, the gNB based on request of the first and/or second apparatus.

32. Apparatus according to claim 1, wherein a first and second reference signal and/or the third and fourth reference signal form a double burst signal;
wherein the first, second, third, fourth reference signals are out of the group comprising:
DL-PRS
SRS
CSI-RS
DM-RS.

33. Apparatus according to claim 1, wherein the second apparatus is configured to perform the measurement on the first set of symbols and to report on the measured phase d_{φ1} or the angle(RS_{22,RX}) and angle(RS_{21,RX})) or more symbols belonging to the same set; and/or wherein the first apparatus is configured to perform the measurement on the second set of symbols and to report on the measured second phase d_{φ2} or angle(RS_{12,RX}) and angle(RS_{11,RX})) or more symbols belonging to the same set.

34. Apparatus according to claim 1, wherein angle (RS_{22,RX}) is defined as being dependent or equal to the phase; and/or
wherein the phase is defined by a measured angle/phase in the frequency domain at one or more sub-carrier or in time domain from a received path of the channel response from the RS signal, wherein the path corresponds to a given path which can be the first detected path by the UE; and/or
wherein the phase is derived from a IQ report of a single or multiple paths.

35. Apparatus according to claim 1, wherein the phase measurements are translated to frequency measurements; and/or where the phase/angle is represented as a change in frequency given by
$${df}_{x} = ( 1 / ( 2 * pi ) ) * ( d {φ}_{x} / {dt}_{x} ) .$$

36. Apparatus according to claim 1, wherein the measurement is performed based on one of the following principles:
Measurement of the phase of a single sub-carrier
Averaging over the phase of several sub-carrier
Calculate the correlation of the transmit and receive signal and report the phase of the correlation “lobe” related to the first arriving path.

37. Apparatus according to claim 36, wherein the report comprises at least one of the following measurements:
Phase of the received signal
Difference of the phase (example: D1 calculates the range. D2 reports the measurement of the phase on the signal received from D1 and reports back the phase difference (d_{φ1} in the example)
Other data (The reports and related measurements are not in the scope of this invention, but the new reports may be added to existing reports), like RTT measurements, signal quality information or beam information.

38. Apparatus according to claim 1, wherein the phase difference calculation and/or the distance calculation and/or a relative speed calculation is performed by the first apparatus, second apparatus and/or a LMF.

39. Another apparatus being the second apparatus and belonging to a positioning system comprising the first apparatus and a second apparatus, the first apparatus comprising a transceiver and configured to communicate to the first apparatus which transmits a first reference signal at a first point of time and at least a second reference signal at a second point of time (first and second reference signal also referred to as double burst forward link) to the second apparatus;
wherein the second apparatus is configured to receive the first and the second reference signal in order to calculate a first phase difference d_{φ1} (d_{φ1} =angle(RS_{22,RX})−angle(RS1_{21,RX})) between the first and the second reference signal and to report the first phase difference d_{φ1} or an angle(RS_{22,RX}) and angle(RS_{21,RX})) to another entity of the positioning system, like the LMF, to the first apparatus;
wherein the second apparatus is configured to transmit a third reference signal at a third point of time and at least a fourth reference signal at a fourth point of time (third and fourth reference signal also referred to as to double burst return link) in response to the first and second reference signal to the first apparatus;
in order to calculate a second phase difference d_{φ2} (d_{φ2}=angle(RS_{12,RX})−angle(RS_{11,RX})) between the third and the fourth reference signal, and to report the second phase difference d_{φ2} or an angle(RS_{12,RX}) and angle(RS_{11,RX})) to another entity, like the LMF, or to the second apparatus;
wherein the another apparatus or the another entity is configured to calculate a distance change or a relative speed of the first and the second apparatus based on the phase difference d_{φ1} and the phase difference d_{φ2} or based on the formula d_{φMovement}=(d_{φ1}+d_{φ2})/2.

40. Apparatus according to claim 1, wherein the apparatus comprises one of the following: a user equipment, mobile device, smartphone, smart device, IoT device, vehicle, road side unit, non-terrestrial component, drone, satellite, gNB (20), NG RAN node, IAB node, TRP, LMF.

41. Positioning system comprising at least the first apparatus according to claim 1 or 2 and the second apparatus according to claim 3 or 39.

42. Positioning system according to claim 41, further comprising a LMF.

43. Positioning system according to claim 42, wherein the LMF is configured to receive a report from the first apparatus or the second apparatus and/or to initiate a measurement performed by the first and/or the second apparatus or to calculate a distance change and/or a relative speed (v) of the first and the second apparatus.

44. Positioning system according to claim 41, wherein the LMF and/or a base station provides a configuration information to the first and/or second apparatus,
wherein the configuration information comprises information on one or more resources to be used for the first reference signal and the second reference signal (e.g. comprising a bandwidth portion, a frequency portion and/or slot information) and/or on the first point of time and second point of time and/or information on resources to be used for the third reference signal and the fourth reference signal (e.g., comprising the bandwidth portion, frequency portion and/or slot information) and/or on the third point of time and the fourth point of time.

45. Method for performing position determination performed by a first apparatus belonging to a positioning system comprising the first apparatus and a second apparatus, the first apparatus, comprising the steps:
transmitting a first reference signal at a first point of time and at least a second reference signal at a second point of time (first and second reference signal also referred to as double burst forward link) to a second apparatus so that the second apparatus receives the first and the second reference signal in order to calculate a first phase difference d_{φ1} (d_{φ1}=angle(RS_{22,RX})
angle(RS_{21,RX})) between the first and the second reference signal and to report the first phase difference d_{φ1} or the angle(RS_{22,RX}) and angle(RS_{21,RX})) to another entity, like the LMF, to the first apparatus;
receiving from the second apparatus a third reference signal at a third point of time and at least a fourth reference signal at a fourth point of time (third and fourth reference signal also referred to as to double burst return link) in response to the first and second reference signal in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus;
calculating a distance or distance change or a relative speed (v) of the first and the second apparatus based on d_{φ1} and d_{φ2} or based on the formula d_{φMovement}=(d_{φ1}+d_{φ2})/2.

46. Method for performing position determination performed by a second apparatus belonging to a positioning system comprising the first apparatus and a second apparatus, the first apparatus, comprising the steps:
receiving a first and at least a second reference signal transmitted by the first apparatus, the first reference signal is transmitted at a first point of time (t₁) and the second reference signal is transmitted at a second point of time (first and second reference signal also referred to as double burst forward link) in order to calculate a first phase difference d_{φ1} (d_{φ1}=angle(RS_{22,RX})−angle(RS_{21,RX})) between the first and the second reference signal and to report the first phase difference d_{φ1} or the angle(RS_{22,RX}) and angle(RS_{21,RX})) to another entity, like the LMF, to the first apparatus;
transmitting a third reference signal at a third point of time and at least a fourth reference signal at a fourth point of time (third and fourth reference signal also referred to as to double burst return link) in response to the first and second reference signal to the first apparatus in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus;
calculating a distance or distance change and/or a relative speed (v) of the first and the second apparatus based on d_{φ1} and d_{φ2} or based on the formula
$$d {φ}_{M o v ement} = ( d {φ}_{1} + d {φ}_{2} ) / 2.$$

47. Method according to claim 44, further comprising one or more of the following steps:
Exchange DL-PRS configuration information on NRPPa;
Exchange information on performing capability;
Performing on-demand PRS procedure;
Transferring assistance data;
Requesting location information;
Performing UE measurements;
Providing location information;
Requesting NRPP a positioning information (i.e. Requesting SRS configuration from NG-RAN node hosting the serving cell);
gNB determines UL SRS resources;
Providing the SRS configuration to the UE;
Positioning information response;
Activation of SRS;
Requesting NRPPa measurement (i.e. making request to several TRPs to measure the uplink SRS);
Measuring UL-PRS (e.g. SRS);
Responding by reporting positioning measurement over NRPPa;
Performing LMF processing.

48. A non-transitory digital storage medium having a computer program stored thereon to perform the method for performing position determination performed by a first apparatus belonging to a positioning system comprising the first apparatus and a second apparatus, the first apparatus, the method comprising the steps:
transmitting a first reference signal at a first point of time and at least a second reference signal at a second point of time (first and second reference signal also referred to as double burst forward link) to a second apparatus so that the second apparatus receives the first and the second reference signal in order to calculate a first phase difference d_{φ1} (d_{φ1}=angle(RS_{22,RX})
angle(RS_{21,RX})) between the first and the second reference signal and to report the first phase difference d_{φ1} or the angle(RS_{22,RX}) and angle(RS_{21,RX})) to another entity, like the LMF, to the first apparatus;
receiving from the second apparatus a third reference signal at a third point of time and at least a fourth reference signal at a fourth point of time (third and fourth reference signal also referred to as to double burst return link) in response to the first and second reference signal in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus;
calculating a distance or distance change or a relative speed (v) of the first and the second apparatus based on d_{φ1} and d_{φ2} or based on the formula
$$d {φ}_{M o v ement} = ( d {φ}_{1} + d {φ}_{2} ) / 2 ,$$
when said computer program is run by a computer.

49. A non-transitory digital storage medium having a computer program stored thereon to perform the method for performing position determination performed by a second apparatus belonging to a positioning system comprising the first apparatus and a second apparatus, the first apparatus, the method comprising the steps:
receiving a first and at least a second reference signal transmitted by the first apparatus, the first reference signal is transmitted at a first point of time (t₁) and the second reference signal is transmitted at a second point of time (first and second reference signal also referred to as double burst forward link) in order to calculate a first phase difference d_{φ1} (d_{φ1}=angle(RS_{22,RX})−angle(RS_{21,RX})) between the first and the second reference signal and to report the first phase difference d_{φ1} or the angle(RS_{22,RX}) and angle(RS_{21,RX})) to another entity, like the LMF, to the first apparatus;
transmitting a third reference signal at a third point of time and at least a fourth reference signal at a fourth point of time (third and fourth reference signal also referred to as to double burst return link) in response to the first and second reference signal to the first apparatus
in order to calculate a second phase difference d_{φ2} (d_{φ2}=angle(RS_{12,RX})−angle(RS_{11,RX})) between the third and the fourth reference signal, and to report second phase difference d_{φ2} the angle(RS_{12,RX}) and angle(RS_{11,RX})) to another entity, like the LMF, or to the second apparatus;
calculating a distance or distance change and/or a relative speed (v) of the first and the second apparatus based on d_{φ1} and d_{φ2} or based on the formula
$$d {φ}_{M o v ement} = ( d {φ}_{1} + d {φ}_{2} ) / 2 ,$$
when said computer program is run by a computer.
